(19) United States
(12) Patent Application Publication
(10) Pub. No.: US 2009/0040564 A1
(43) Pub. Date: Feb. 12, 2009

(54) Vision-Based Color and Neutral-Tone Management

(75) Inventor: Edward M. Granger, Novato, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: IQ Colour, LLC, Novato, CA (US)

(21) Appl. No.: 12/181,154

(22) Filed: Jul. 28, 2008

Related U.S. Application Data
(63) Continuation-in-part of application No. 11/336,202, filed on Jan. 21, 2006.
Application No. 11/336,202 is a continuation-in-part of application No. 11/336,203, filed on Jan. 21, 2006.

(51) Int. Cl. G06K 15/02

(52) U.S. Cl. 358/2.1

(57) ABSTRACT

A color management system for image reproduction and rendering. Images are rendered to appear perceptually accurate, rather than merely calorimetrically accurate. For example, an image reproduced by a color printer will be perceived as an accurate reproduction of the same image displayed on a computer screen, or that an image displayed on a computer screen is perceived as an accurate reproduction of the same scanned image or photographed image, even though the reproductions may be constrained by other factors, such as paper or substrate darkness, or a limited color gamut of the reproduction process.

### CROSS REFERENCE TO RELATED APPLICATIONS

This application is a continuation-in-part of the following two U.S. applications, the entire disclosures of which are incorporated by reference:
U.S. patent application Ser. No. 11/336,202, filed Jan. 21, 2006 by Edward M. Granger for “Color and Darkness Management System”; and
U.S. patent application Ser. No. 11/336,203 filed Jan. 21, 2006 by Edward M. Granger for “Color and Neutral Tone Management System.”

### BACKGROUND OF THE INVENTION

The present invention, in general, relates to color management systems, and more particularly, relates to color and brightness modeling and appearance transformation for perceptually accurate image and graphical rendering for graphical arts, printing, publishing, and display technologies.

Color rendering technologies have continued to evolve with other technologies, such as color display technologies (e.g., cathode ray tube (CRT) displays, flat panel displays), color printing technologies, scanning technologies, and publishing technologies. For example, an individual may now capture a color image through a digital camera or scanner, and using computer software such as Adobe Photoshop, may manipulate the image and print the resulting product. As the image is displayed on a computer display screen or other user interface, it has become desirable for the resulting printed image to be a perceptually accurate match of the displayed image.

Typically, each pixel of the displayed image is specified utilizing the additive primaries of red (“R”), green (“G”) and blue (“B”) (collectively referred to as “RGB”) data which, when combined in the specified combination, results in the display of the selected color, such as red and green combining to produce yellow. A standard RGB specification has been developed, referred to as “sRGB”, particularly suited for use in electronic displays, such as active matrix, LCD, CRT or plasma displays. Other RGB standard specifications are also available and utilized by those of skill in the color management and rendering arts and sciences.

Conversely, typical color printing technologies utilize a selected combination of subtractive primaries and black, typically implemented utilizing at least four inks, cyan (“C”), magenta (“M”) yellow (“Y”) and black (“K”) (collectively referred to as “CMYK”). Depending upon the printing technology, additional ink colors may also be utilized, providing systems having 6 or 8 printing colors, for example. The various overprints of CMYK combine to produce other colors, such as cyan and magenta combining to produce blue, and yellow and magenta combining to produce red.

The prior art documents numerous attempts and systems to provide accurate color rendering, typically defining a color space which may be utilized to specify a particular color, as perceived by a “standard” observer, in terms of its hue (perceived color), lightness/darkness (degree to which the perceived color is equivalent to one of a series of grays ranging from black to white), and saturation or chroma (the amount or degree of color of the same hue (or departure from a gray of the same lightness). Such color spaces are often defined using standardized tristimulus values, such as the CIE (Commission Internationale de l'Eclarage) XYZ color space (1931), the CIELAB space, Munsell values, and so on.

The various prior art systems, however, typically result in similar difficulties and inaccuracies. For example, colors may have equally measured luminance (Y component), yet are perceived differently, particularly with blue colors being perceived as less brighter than yellow colors having the same measured luminance values. Similarly, most rendering of dark colors by extant methods results in the color components of the printed image being replaced by black, such that a dark blue is inaccurately rendered as a black color, resulting in a loss of color in an image reproduction.

In addition, various colors created under one set of lighting conditions often appear to be different under other lighting conditions, as a phenomenon referred to as “metamerism”. As various combinations of cyan, yellow and magenta are typically utilized to create neutral tones (e.g., grays), metamerism is often a significant concern in the prior art, with color rendering forced to be based upon the predicted lighting conditions for the consumer or observer, such as incandescent lighting used in a home, compared to fluorescent lighting in an office or to daylight from outdoors.

As a consequence, a need remains for a color management system which provides perceptually accurate image reproduction, such that an image produced by a color printer is perceived as an accurate reproduction of the same image displayed on a computer screen, or that an image displayed on a computer screen is perceived as an accurate reproduction of the same scanned image or photographed image, for example. Such a color management system should further provide for such perceptually accurate rendering across a wide variety of printing media and display systems, without requiring corresponding changes to the original image.

### SUMMARY OF THE INVENTION

Embodiments of the present invention prove a wide gamut—vision based RGB color space that is operating system neutral and computationally efficient. The space has a companion uniform chromaticity space that offers an alternative to the CIELAB color space.

The new RGB rendering space, IQRGB, described herein is based on the actions of the human visual system. Embodiments of the color space offer better arithmetic precision, color space uniformity and support for automatic white point correction. Prior art color spaces such as the CIEXYZ space are structure so that much of the vector space is not used to render “real world” images. This requires using more bits of computational precision in XYZ just to guarantee 8-bit precision in rendered images. The present IQRGB color space employs a vision based RGB color space that is wrapped tightly around the gamut of real world colors. IQRGB is designed to fit the “real world” color gamut insuring the system is 8-bit friendly.

The exemplary embodiments of the present invention provide a new color management system for image reproduction and rendering. Images are rendered in accordance with embodiments to appear perceptually accurate, rather than merely calorimetrically accurate. For example, the exemplary embodiments provide that an image reproduced by a color printer will be perceived as an accurate reproduction of the same image displayed on a computer screen, or that an image displayed on a computer screen is perceived as an accurate reproduction of the same scanned image or photographed image, even though the reproductions may be constrained by other factors, such as paper or substrate darkness, or a limited color gamut of the reproduction process.

The exemplary embodiments of the inventive color, darkness and neutral tone management system further provides for such perceptually accurate rendering across a wide variety of printing media and display systems, without requiring corresponding changes to the original image, using a concept of a “meta printer.” The exemplary embodiments reduce metameric effects and reduce the amounts of expensive colored inks utilized in image reproduction, to provide a substantially better image quality and to result in a substantial savings in ink usage.

Digital photography and scanning are becoming a dominant source of images for reproduction systems, whether it is for home or professional use. Therefore, RGB is becoming the color space of choice. The selection of the RGB primaries in the IQRGB system is not arbitrary. They support a uniform appearance transform. The new transform has tristimulus values denoted ATD. The transform from IQRGB to ATD is a “best” approximation to the known channels of human vision. The new model, while being linear and integer, produces a uniform chromaticity space denoted Qtd. A computationally simple model answers the need for a space that produces uniform color differences.

The ICC workflows use the CIELAB color space as the basis for transforming RGB to the colorant system used by an output device. The current practice is to convert color data to a standard CMYK. If the image data is to be rendered on a device that has nonstandard colorants, the CMYK data has to be transformed back to CIELAB. The CIELAB image must be re-transformed for reproduction on the nonstandard printer. This process has many flaws and limitations. The IQRGB system is being developed and tested with known vision data. IQRGB will be compared to CIE xyY and CIELAB using the same vision data.

An exemplary process has the following tables:
1. A colorant table;
2. A saturation boundary table;
3. A darkness table; and
4. Dot gain tables for each colorant used.

The colorant table is indexed by hue and saturation. This table contains the amount of each colorant (can be any number but often two) and the amount of darkness the indexed colorants produce for each (hue, saturation) index. The saturation boundary table, indexed by hue, is used to compute the saturation index given the input tristimulus values (example RGB, XYZ. and Lab).

The darkness table is indexed by the ratio of the darkness of the input pixel to the darkness given in the colorant table for the (hue, saturation) of the input pixel. The darkness table contains the amount of each colorant (maybe many) required to achieve the indexed darkness addition to the colorants found by indexing the colorant table. The colorants used in addition to the neutral component (black) are used to interpolate darkness levels between those that can be reproduced using the neutral colorant alone. The interpolating colorants can be used in any combination to achieve a smooth monotonic increase in darkness.

The darkness table also contains an attenuation factor that is applied to the colorants of determined from the colorant table so that proper hue and saturation is maintained throughout the entire range of darkness. If for any reason the input pixel is less dark that the darkness of that given by the colorant table, then no darkness is added as would otherwise be specified by the darkness table. The darkness table is substantially nonlinear to correct for the darkness of the substrate and the maximum darkness achievable by the colorants used. The nature of the nonlinearity is to produce the appearance that the image is brighter and darker than an image produced using calorimetrically accurate darkness values.

The output value for each colorant is given by:

colorant(n)=darkness table attenuation factor (darkness index)* colorant (hue, saturation)+darkness table (colorant, darkness index),

the output for the neutral colorant (black) is given by:

black=darkness table (black, darkness index), and

the dot gain tables for each colorant used are applied as follows to

colorant(out)=dot gain table (output value of colorant from results above).

Based on the meta RGB primaries that compactly encompass the real world colors, an ATD space is defined as follows:

A=R+3*G

T=R−G

D=(R+G)/2−B

The ATD space is converted to Uniform Perception Space by first computing brightness.

In another aspect of the invention, a brightness term is developed in recognition that luminance given by either Y or A in the above equation does not predict the brightness of a given color. This is known as the Helmholtz-Kohlrausch (H-K) effect where the chromatic channels of the visual system produce a brightness that is not equal to the luminance predicted by CIE Y. One form of this brightness term, Q, that does compensate for the Helmholtz-Kohlrausch effect is given as follows:

Q=A+T/2 if D>0

Q=A+T/2−3D/4, otherwise,

with chromaticity coordinates “t” and “d” defined relative to “Q”, as t=T/Q and d=D/Q. A hue (H), saturation (S), and value (V) space is defined as follows:

V=Q/Qwhite,

S=the greater of |d| or |t|,

H=ratio of t and d,

where Qwhite is the Q value of a D65 white for the system under study, and H is scaled to be in the inclusive range of 0-255.

In an aspect of the invention, it has been recognized that a model where the D axis passes through unique blue and unique yellow on the spectrum locus, the axis also passes through points representing black bodies including D65, and the visual model for white point adaptation entails the balance of the blue cone sensitivity to that of the combined red and green cones. This is interpreted that the blue cones are adapting to maintain the appearance while at the D65 “natural” point in the model.

Based on this interpretation, the colorimetry of all colorants is defined in a substrate-independent manner. Spectral measurements of the reflections from colorant patches and bare substrate are made, and the recorded calorimetric values are obtained for each colorant patch by dividing the colorant-on-substrate reflectivity by the substrate reflectivity. This produces a substrate free color description. With this assumption, normalized white produced by the action of the eye and brain—color defined in this matter maintains its chromatic appearance of (hue, saturation and value) independent of the substrate as long as the substrate appears to be white to the viewer.

Using this definition, the dot gain and chromaticity gain of the colorants as used in the reproduction process are determined. For a CMYK system C, M, Y, CM, CY, MC, K can be used to make a tonal step target. That is, measurements are made of the primary colors and the appropriate over prints. The dot gain is measured using a narrowband spectral filter (10 nm bands in an example). The center frequency of this filter is placed at the wavelength where the spectral reflectance is minimum for the patch that has the global lowest reflectance. The dot gain is defined as follows:

dot area=(1−R(patch))/(1−R(min))

where R (patch) is the spectral reflectivity of the tint patch and R (min) is the reflectivity of the patch that has the global lowest reflectance. Reflectivity is a function of wavelength, and the reflectivity used in the equation above is obtained from the wavelength band where the modal reflectivity is minimum for all tint steps. The dot gain is given by:

DG=dot area measured−dot area requested

The deviation (dot gain) from linearity can be used to correct (linearize) the output device to permit working in linear dot area of linear reflectivity. At the time of correcting for dot gain, the saturation (chromaticity) of patches used in the linearization step is also measured. As shown in FIG. 5, if saturation is plotted as a function of true dot area that maximum saturation may occur before reaching full dot area. In these cases, only those dot areas less than and equal to the maximum saturation are used in the output device characterization. This imposition of chromaticity gain limits eliminates using ink coverage that would waste ink and only contribute darkness that can be accomplished by adding black ink.

The single-colorant and overprint patches are used to find combinations of CMY (or more) that will produce the lightest colors for all sampled hues and saturation. The patches used in at least one example were use to interpolated color combinations for 256 hue angle and 192 saturation level for each hue. The bright colors thus determined are darkened by adding color dyes and black ink.

Accordingly, for an exemplary printer calibration, the CIE XYZ tristimulus values are measured for each tint patch, but the calculation of the tristimulus values has been modified for purposes of the new calibration procedure. The spectral reflectivities of the substrate and of the colorant on the substrate are measured at 10 nm intervals across the visible spectrum. The reflectivity of the colorant is corrected for the reflectivity of the substrate at each wavelength interval. The XYZ tristimulus values are computed for a D65 white point.

The calibration of an output device starts by printing a number of tint steps from zero to 100% dot area. Tint steps are made for the primary colorants and the combinations of dye sets. Uniform tint steps sent to the device do not result in equal steps in dot area. The dot area is calculated as above.

The XYZ values are converted to hue, saturation and value. Saturation (chromaticity) is plotted as a function of the dot area. The saturation (chromaticity) gain is not a linear function of dot area. Maximum saturation usually occurs at values of dot area less than the maximum. Therefore maximum colorant use does not usually produce the maximum saturation. Dot areas are determined that will give equal steps in saturation. These areas are used to develop a denser sample grid from which the final printer map is developed. The samples from the dense sample grid are used to determine the maximum saturation at each sampled hue. These values are used in the next step where the saturation is companded to the saturation boundary of the meta space.

Embodiments of the present invention improve over the old photomechanical separation model, which uses large amounts of colored dyes to produce the required darkening, with black being added only at higher levels of darkness. A process called Gray Component Removal (GCR) reduced the amount of color ink being used in the old model by removing some of the color dyes and replacing them with an equivalent amount of black ink. However, at the same time it also reduced the colorfulness of the original image.

Removing the constraints of the old system led to the discovery that in a CMY system, the color component that was contributing the least to the color was the element that was contributing to the darkening of the color produced by the other two components. Black ink is substituted for the least color component produced the same result of darkening without the need to reduce the other two color components. The new method darkens a color without reducing the chromaticity of the color.

With the constraints removed, CMY can now be used in a completely different manner. They can be used in small amounts to help interpolate many more levels of darkness, as seen in FIG. 11. This change in colorant used here can provide one or more of the following advantages:
dramatic color ink saving;
more colorful images than those produced using GCR;
sharper images (effectively higher printer resolution) since the luminance image is being carried by the single black file; and
reduction in metamerism is a result of using only small color components in the darkening model (since black is the major component used in darkening a color, this removes the metameric problem produced by the color inks).
   While individual features described herein provide improvements, a surprisingly dramatic color ink saving arises from the combination of (1) imposing chromaticity gain limits in the output device characterization and (2) increasing black ink while reducing color inks to increase darkness.

An aspect of the invention includes companding. Most of color science uses 3×3 matrices to convert from one calorimetric system to another. There is a concern of compactness or the fact that a large volumetric space cannot be transformed to a smaller space without some of the vector components becoming negative. This method described here eliminates this problem by use of a compander that either expands or contracts the color volume to fit the volume of the meta-printer. The compander is of the form:

O=K1*I/(K2+I)

where O is the output companded value and I is input to the compander. Saturation and value are companded, but hue should be reproduced accurately for the best appearance of the transformed color.

An aspect of the invention includes darkness companding wherein the darkness model is modified to correct for the darkness of the paper and the maximum darkness (density) that can be achieved with the available colorants. Images on darker papers tend to have poor contrast and image quality. This problem can be corrected by using a visual effect called crispening. Increasing the contrast of the image at a given point on the darkness curve will give the appearance of higher dynamic range in the image. The crispening point is placed at approximately the 75% point in the darkness range. The slope of the contrast increase at this point depends on the difference in darkness between the minimum darkness of the substrate and the maximum darkness of the combination of the substrate on the maximum darkness that can be obtained from the colorants on the paper.

The darkness companding function has the form,

Dout=K1*(D−Cr)/(K2+[D−Cr]), if D>Cr, and

Dout=K3*(Cr−D)/(K4+[Cr−D]), otherwise,

where D is the darkness add for a perfect white substrate, Cr is the darkness of the crispening point, Dout is the darkness entry into the darkness tables. K1, K2, K3, and K4 are chosen to produce to desired slope correction at the crispening point.

An aspect of the invention includes covering power correction. The colorants used in graphic reproductions are transparent and not perfect in absorbing out of band radiation. This is usually termed lack of covering power. The lack of covering is a problem in the dark regions of an image. The inability of black to cover the chromatic components of the image produces unwanted contours in the image. A new concept has been added to the darkening model where the chromatic components of the image are reduced as a function of the darkness being added to the image.

The equation for each of the output pixel colorants is:

Cout=K(D)*Cin+C(D)

where Cout is the amount of colorant used in the reproduction, Cin is the amount of colorant for zero darkness, C(D) is the amount of colorant used for darkness interpolation at darkness level D and K(D) is the correction for lack of covering power at that darkness level.

A further understanding of the nature and advantages of the present invention may be realized by reference to the remaining portions of the specification and the drawings.

### BRIEF DESCRIPTION OF THE DRAWINGS

FIG. 1 is a block diagram illustrating exemplary color management system and apparatus embodiments in accordance with the teachings of the present invention;

FIGS. 2A and 2B provide a graphical diagram illustrating an exemplary ATD color space in accordance with the teachings of the present invention;

FIG. 2C is a graphical diagram illustrating the CIE 1931 spectrum locus as transformed and displayed as a function of the t and d chromaticity coordinates;

FIG. 2D is a graphical diagram illustrating an exemplary set of ATD color mixing functions;

FIG. 3 is a graphical diagram illustrating Munsell colors, which are perceptually equally spaced in hue and chroma, as mapped to a CIE XYZ color space and to an exemplary ATD color space;

FIG. 4 is a graphical diagram illustrating exemplary vectors within a “td” chromaticity coordinate system in accordance with the teachings of the present invention;

FIG. 5 is a graphical diagram illustrating an exemplary chromaticity gain limit in accordance with the teachings of the present invention;

FIG. 6 is a graphical diagram illustrating an exemplary saturation (chromaticity gain) compander in accordance with the teachings of the present invention;

FIG. 7 is a diagram illustrating an exemplary overprint chromaticity gain limit in accordance with the teachings of the present invention;

FIG. 8 is an exemplary 100-step chart for color management system linearization in accordance with the teachings of the present invention;

FIG. 9 is a graphical diagram illustrating an exemplary chroma reduction and convergence to black chromaticity point in accordance with the teachings of the present invention;

FIG. 10 is a graphical diagram illustrating an exemplary darkness and brightness model in accordance with the teachings of the present invention;

FIG. 11 is a graphical diagram illustrating an exemplary darkness output for black and neutral models in accordance with the teachings of the present invention;

FIG. 12 is a diagram illustrating an exemplary neutral model in accordance with the teachings of the present invention;

FIG. 13 is a graphical diagram illustrating an exemplary chroma reduction for a darkness model in accordance with the teachings of the present invention;

FIG. 14 is a diagram illustrating exemplary proportional out-of-gamut companding in accordance with the teachings of the present invention;

FIG. 15 is a hex chart for color management system calibration in accordance with the teachings of the present invention;

FIGS. 16A and 16B, taken together, provide a flow chart for determining colorant values for the color management methodology in accordance with the teachings of the present invention, and may be embodied as software, for example;

FIG. 17 provides a comparison of the spectral shape of the IQRGB normalization factor (brightness-luminance ratio) with that of the Helmholtz-Kohlrausch (H-K) effect;

FIGS. 18A-18C show wavelength discrimination data from the literature, wavelength discrimination data modeled for the IQRGB in an embodiment of the present invention, and wavelength discrimination data modeled for CIELAB;

FIG. 19 shows the uniformity of the IQRGB model as compared to the CIExyY and CIELAB color spaces when applied to uniform color scales of the OSA Color Systems;

FIG. 20 shows the uniformity of the IQRGB model as compared to the CIExyY and CIELAB color spaces when applied to uniform color scales of the Munsell Renotation System;

FIG. 21 shows the color matching of the IQRGB model as compared to the CIExyY and CIELAB color spaces when applied to the MacAdam color matching ellipses; and

FIG. 22 shows the color matching of the IQRGB model as compared to the CIExyY and CIELAB color spaces when applied to the Wyszecki-Fielder.

### DESCRIPTION OF SPECIFIC EMBODIMENTS

### Introduction and Hardware Overview

While the present invention is susceptible of embodiment in many different forms, there are shown in the drawings and will be described herein in detail specific examples and embodiments thereof, with the understanding that the present disclosure is to be considered as an exemplification of the principles of the invention and is not intended to limit the invention to the specific examples and embodiments illustrated. A color space according to embodiments of the present invention is referred to as the IQRGB color space.

The present invention is modeled upon how an artist may utilize his or her palette of colors, rather than modeled upon traditional color separation techniques utilizing red, green, and blue filters to produce separations into cyan, magenta, and yellow, respectively. Instead, the present invention focuses on developing the selected hue and saturation of the brightest available colors, which are then proportionally darkened, such as by shadow. The present invention utilizes various chromaticity gain, darkness/brightness and neutral modeling to provide an “appearance” transform to produce a perceptually accurate image reproduction, rather than a calorimetrically accurate reproduction. In addition, to further maintain image appearance, the exemplary embodiments utilize a proportional companding or compression of out-of-gamut brightness levels, to preserve comparative proportions in resulting reproductions.

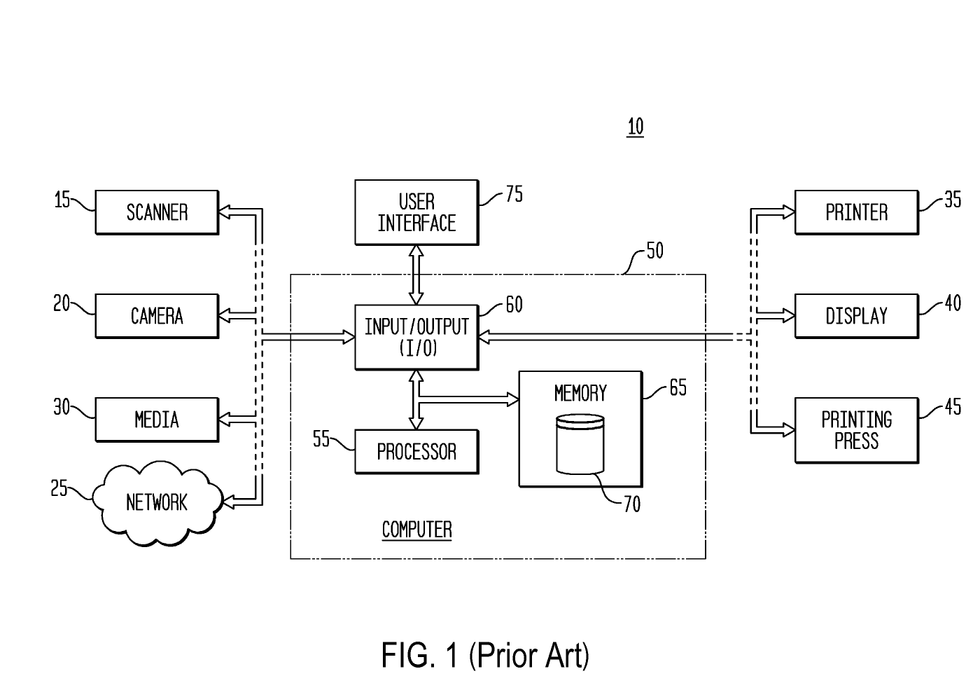

FIG. 1 is a block diagram illustrating exemplary color management system 10 and apparatus 50 embodiments in accordance with the teachings of the present invention. As illustrated, the apparatus 50 may be embodied as a computer, a server, or any other type of processing or controlling device, such as a printing system controller utilized in the graphic arts and printing fields. Image or data input for the system 10 may be provided through any of a plurality of input devices, such as a color scanner 15 or color (digital) camera 20, or may be provided in the form of electronic data (e.g., electronic files), through a network 25 (such as the Internet, a cable network, or the public switched telephone network, for example) or computer (machine) readable media 30, such as a floppy disk, a CD-ROM, a memory card, etc.

In addition, input images may be generated through a user interface 75 coupled to or forming part of the apparatus 50, such as though a keyboard, computer mouse, pointing device, which may include a display (e.g., 40) for visual presentation of the image. For example, an individual may utilize the user interface and apparatus 50 to create a graphics image or other artwork, using any available graphics or photography software.

Similarly, image or data output from the color management system 10 may be provided to any of a plurality of output devices such as a printer 35 (e.g., a laser or inkjet printer), an electronic display 40, such as a CRT, plasma or LCD display, or a printing press 45, for example. In addition, output may also be provided in the form of electronic data through network 25 or machine-readable media 30, such as to transmit to another location or a remote location, (e.g., from an office to a printing plant or facility).

As illustrated in FIG. 1, the apparatus 50 comprises a processor 55, an input and output (“I/O”) interface (or other I/O means) 60, and a memory 65 (which may further comprise the data repository 70). In the apparatus 50, the interface 60 may be implemented as known or may become known in the art, to provide data communication between, first, the processor 55, memory 65 and/or data repository 70, and second, any of the various input and output devices, mechanisms and media discussed herein, including wireless, optical or wireline, using any applicable standard, technology, or media, without limitation. In addition, the I/O interface 60 may provide an interface to any CD or disk drives, or an interface to a communication channel for communication via network 25, or an interface for a universal serial bus (USB), for example. In other embodiments, the interface 60 may simply be a bus (such as a PCI or PCI Express bus) to provide communication with any form of media or communication device, such as providing an Ethernet port, for example. Also for example, the I/O interface 60 may provide all signaling and physical interface functions, such as impedance matching, data input and data output between external communication lines or channels (e.g., Ethernet, TI or ISDN lines) coupled to a network 25, and internal server or computer communication busses (e.g., one of the various PCI or USB busses), for example and without limitation. In addition, depending upon the selected embodiment, the I/O interface 60 (or the processor 55) may also be utilized to provide data link layer and media access control functionality.

The memory 65, which may include a data repository (or database) 70, may be embodied in any number of forms, including within any computer or other machine-readable data storage medium, memory device or other storage or communication device for storage or communication of information such as computer-readable instructions, data structures, program modules or other data, currently known or which becomes available in the future, including, but not limited to, a magnetic hard drive, an optical drive, a magnetic disk or tape drive, a hard disk drive, other machine-readable storage or memory media such as a floppy disk, a CDROM, a CD-RW, digital versatile disk (DVD) or other optical memory, a memory integrated circuit (“IC”), or memory portion of an integrated circuit (such as the resident memory within a processor IC), whether volatile or non-volatile, whether removable or non-removable, including without limitation RAM, FLASH, DRAM, SDRAM, SRAM, MRAM, FeRAM, ROM, EPROM or E²PROM, or any other type of memory, storage medium, or data storage apparatus or circuit, which is known or which becomes known, depending upon the selected embodiment. In addition, such computer readable media includes any form of communication media which embodies computer readable instructions, data structures, program modules or other data in a data signal or modulated signal, such as an electromagnetic or optical carrier wave or other transport mechanism, including any information delivery media, which may encode data or other information in a signal, wired or wirelessly, including electromagnetic, optical, acoustic, RF or infrared signals, and so on. The memory 65 is adapted to store various programs or instructions (of the software of the present invention) and database tables, discussed below.

The apparatus 50 further includes one or more processors 55, adapted to perform the functionality discussed below. As the term processor is used herein, a processor 55 may include use of a single integrated circuit (“IC”), or may include use of a plurality of integrated circuits or other components connected, arranged or grouped together, such as microprocessors, digital signal processors (“DSPs”), parallel processors, multiple core processors, custom ICs, application specific integrated circuits (“ASICs”), field programmable gate arrays (“FPGAs”), adaptive computing ICs, associated memory (such as RAM, DRAM and ROM), and other ICs and components. As a consequence, as used herein, the term processor should be understood to equivalently mean and include a single IC, or arrangement of custom ICs, ASICs, processors, microprocessors, controllers, FPGAs, adaptive computing ICs, or some other grouping of integrated circuits which perform the functions discussed below, with associated memory, such as microprocessor memory or additional RAM, DRAM, SDRAM, SRAM, MRAM, ROM, FLASH, EPROM or E²PROM. A processor (such as processor 55), with its associated memory, may be adapted or configured (via programming, FPGA interconnection, or hard-wiring) to perform the methodology of the invention, as discussed below. For example, the methodology may be programmed and stored, in a processor 55 with its associated memory (and/or memory 65) and other equivalent components, as a set of program instructions or other code (or equivalent configuration or other program) for subsequent execution when the processor is operative (i.e., powered on and functioning). Equivalently, when the processor 55 may implemented in whole or part as FPGAs, custom ICs and/or ASICs, the FPGAs, custom ICs or ASICs also may be designed, configured and/or hard-wired to implement the methodology of the invention. For example, the processor 55 may implemented as an arrangement of microprocessors, DSPs and/or ASICs, collectively referred to as a “processor”, which are respectively programmed, designed, adapted or configured to implement the methodology of the invention, in conjunction with one or more databases (70) or memory 65.

As indicated above, the processor 55 is programmed, using software and data structures of the invention, for example, to perform the methodology of the present invention. As a consequence, the system and method of the present invention may be embodied as software which provides such programming or other instructions, such as a set of instructions and/or metadata embodied within a computer readable medium, discussed above. In addition, metadata may also be utilized to define the various data structures of database 70, such as to store the various color management models and calibrations discussed below.

More generally, the system, methods, apparatus and programs of the present invention may be embodied in any number of forms, such as within any type of apparatus (computer or server) 50, within a processor 55, within a computer network, within an adaptive computing device, or within any other form of computing or other system used to create or contain source code, including the various processors and computer readable media mentioned above. Such source code further may be compiled into some form of instructions or object code (including assembly language instructions or configuration information). The software, source code or metadata of the present invention may be embodied as any type of source code, such as C, C++, Java, Brew, SQL and its variations (e.g., SQL 99 or proprietary versions of SQL), DB2, XML, Oracle, or any other type of programming language which performs the functionality discussed herein, including various hardware definition languages (e.g., Verilog, HDL) when embodied as an ASIC. As a consequence, a “construct”, “program construct”, “software construct” or “software”, as used equivalently herein, means and refers to any programming language, of any kind, with any syntax or signatures, which provides or can be interpreted to provide the associated functionality or methodology specified (when instantiated or loaded into a processor or computer and executed, including the apparatus 50 or processor 55, for example). For example, various versions of the software may be embodied as discrete look up tables and mathematical calculations, implemented utilizing programs such as Excel®.

The software, metadata, or other source code of the present invention and any resulting bit file (object code or configuration bit sequence) may be embodied within any tangible storage medium, such as any of the computer or other machine-readable data storage media, as computer-readable instructions, data structures, program modules or other data, such as discussed above with respect to the memory 65, e.g., a floppy disk, a CDROM, a CD-RW, a DVD, a magnetic hard drive, an optical drive, or any other type of data storage apparatus or medium, as mentioned above.

As discussed in greater detail below, the various models of the present invention, such as a chromaticity gain model, a combined darkness and brightness model, and a neutral value model, may be provided as digital values maintained in a relational database table, such as in the database 70. More specifically, for greater computational speed and efficiency, particularly when any selected image may include hundreds of millions of pixels, lookup database tables are maintained to provide output colorant values (such as CMYK, RGB, or other inking or printing system values), which have been calibrated for a selected output device, and which values have been modified in advance according to the models of the present invention. For example, for the darkness and brightness nonlinear companding of the present invention, discussed below with reference to FIGS. 9-11, every input darkness value is mapped (and companded) to a corresponding output darkness value, with the output value stored in advance in the table, rather than calculated in real time. In addition, the tables are indexed (or accessed) according to corresponding tristimulus values, which may be any of the various types of tristimulus values discussed below, in addition to the exemplary ATD or Qtd values. As a consequence, input tristimulus values for a selected pixel are utilized to perform a rapid database table lookup, which then provides the corresponding output colorant and darkness values to drive, for example, a selected color printer or printing press, thereby minimizing computational time during image reproduction.

In addition, while the present invention is frequently illustrated with respect to CMYK and RGB colorant systems, it should be understood that any colorant, printing and/or inking system is within the scope of the present invention. For example, the present invention may be utilized with any of the six or eight colorant systems typically utilized in the printing and publishing industries, which typically include a selection of both primary and secondary colorants, such as hexachrome, CMYOGK, etc. In addition, colorant systems may also include more complex systems, in which both light and dark versions of colorants are utilized.

### ATD Color Space and IORGB Primaries

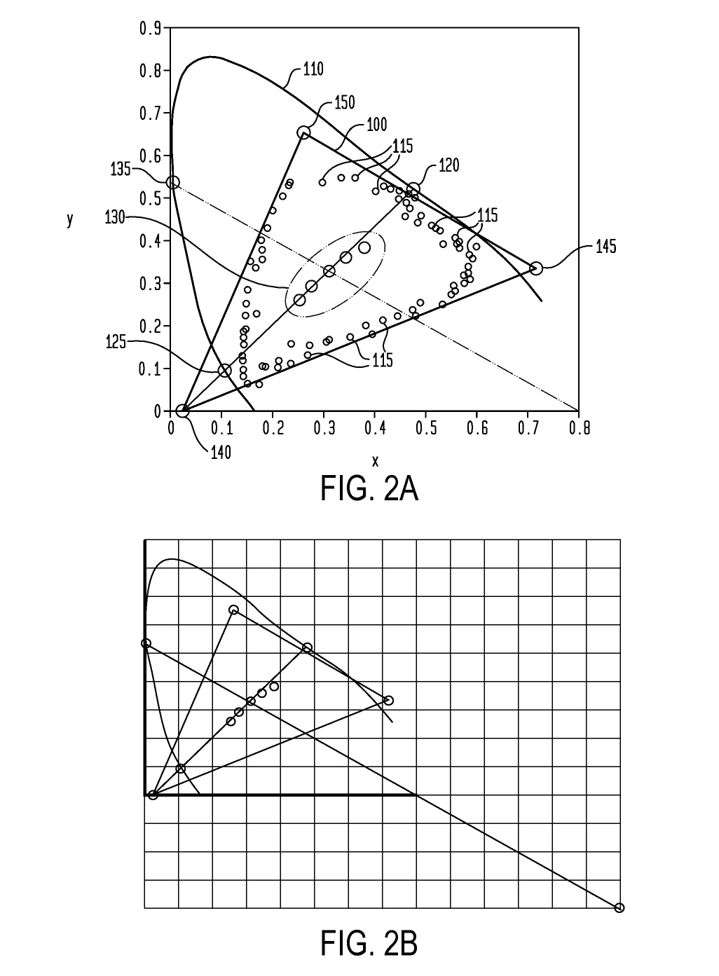

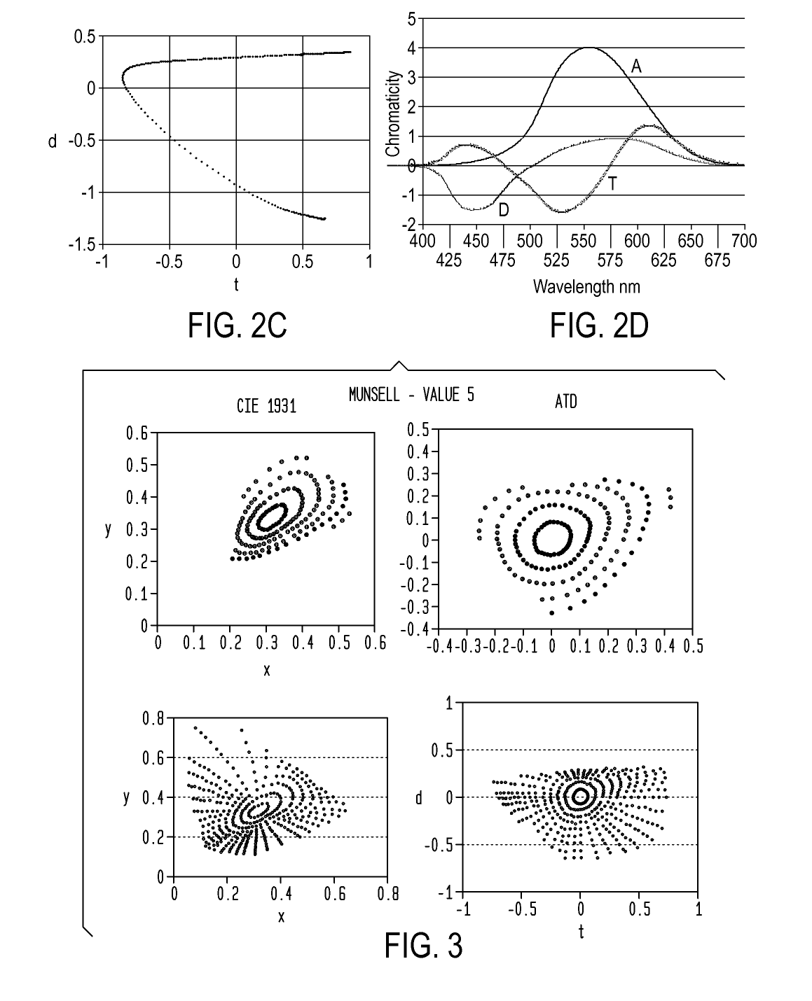

FIGS. 2A and 2B provide a graphical diagram, using the x and y chromaticity coordinates of the CIE xyY color space, illustrating an exemplary ATD color space in accordance with the teachings of the present invention. The present invention utilizes an exemplary color coordinate system based on perceived brightness, referred to as “Qtd”, as a transform of an exemplary new color space referred to as “ATD”, as defined below. Importantly, such Qtd transform and ATD color space may be determined directly from a 3×3 matrix transformation from standard color spaces such as CIE XYZ (1931), “meta” RGB, as illustrated below, and using these transforms, may then be derived further from other standard color definitions, such as CIELAB or CIE Luv. As a consequence, while the invention is described with reference to ATD and Qtd, it will be understood by those of skill in the art that the invention is not limited to any specific color space or chromaticity coordinate system, and all such systems are within the scope of the present invention.

The ATD color space is defined to have three tristimulus values, a luminance component (“A”) and 2 biometrically orthogonal, opponent color difference components, with “T” being a red-green opponent component and “D” being a weighted yellow-blue opponent component. More specifically, the ATD color space may be defined in terms of a RGB color space(s), such as a “meta” RGB color space, as follows (Equation 1):

$$[ \begin{matrix}A \\ T \\ D\end{matrix} ] = [ \begin{matrix}1 & 3 & 0 \\ 1 & - 1 & 0 \\ 1 / 2 & 1 / 2 & - 1\end{matrix} ] [ \begin{matrix}R \\ G \\ B\end{matrix} ] \qquad ( 1 )$$

resulting in the tristimulus ATD values of A=R+3G, T=R−G, and D=(R+G)/2−B. Other RGB color spaces may be utilized similarly, such as sRGB.

Similarly, the ATD color space may be defined in terms of the standard CIE XYZ color space (1931), as follows (Equation 2):

$$[ \begin{matrix}A \\ T \\ D\end{matrix} ] = [ \begin{matrix}0.0 & 4.0 & 0.0 \\ 2.506 & - 2.306 & - 0.0688 \\ 0.4427 & 0.5988 & - 0.9369\end{matrix} ] [ \begin{matrix}X \\ Y \\ Z\end{matrix} ] \qquad ( 2 )$$

As a consequence, the luminance component “A” is a weighted (4×) version of the CIE luminance component “Y”, while the T and D components are weighted values of all three CIE XYZ tristimulus values.

The resulting color gamut is illustrated in FIGS. 2A and 2B, which illustrate an exemplary ATD color space using the CIE xy chromaticity coordinates, in accordance with the teachings of the present invention. As illustrated, the ATD color space (within illustrated triangle 100 defined by the red, green and blue primaries) lies within the CIE horseshoe-shaped spectrum locus 110. The ATD color space has a unique yellow 120, a unique blue 125, daylight illuminants 130 (e.g., D65) lying on the yellow-blue axis, a unique green 135, a blue primary 140, a red primary 145, a green primary 150. The ATD color space encloses all “real world” colors, illustrated by their outer boundary of colors 115, such as all available colors of Kodak Ektachrome®. ISO-12640-3, among other things, specifies a reference color gamut.

Colorants to be utilized in image reproduction may also be measured, preferably in 10 nm increments, and preferably having UV light excluded to eliminate extraneous fluorescence. Substrates such as paper may be similarly measured. The final spectral reflectance of such color samples, for each wavelength increment, is the colorant reflectance divided by the paper reflectance. The ATD tristimulus values are then derived by assuming the normalized reflectance is illuminated by a D65 light source.

This central use of D65 illuminants in defining ATD is quite helpful, as whites under D65 lighting conditions also appear white when viewed under other lighting conditions, such as typical tungsten lighting utilized in homes. As an observer adapts their perception of white to be that of D65 conditions, the colors of the image itself are also perceived as if under D65 illumination as well.

Opponent-process color vision theory is well known. The hue of a color can be described in terms of its redness and greenness and its yellowness and blueness. This process is called opponent because the opponents yellow-blue and red-green are not seen simultaneously. The red-green and yellow-blue responses are independent of one another. Therefore, one can never see a spectacular red-green or a beautiful yellow-blue.

The IQRGB primaries are selected to produce an opponent-process based on the perceptually unique blue, green and yellow hues. The deuteranopic confusion point is used as the extraspectral red opponent. The unique blue, green, and yellow hues are at wavelengths; 475, 500, and 575 nm. The extraspectral red (shown at the right bottom corner of FIG. 2B) is located at x=1.4, y=−0.4 (Wyszecki, 1982a) of the CIE xyY color space. The lines connecting the opponent hues are used as the axes of the color model. The line connecting unique red and green is the T axis and yellow and blue, the D axis. The achromatic axis is denoted A. ATD can be converted to CIEXYZ by using the 3×3 matrix of Equation (2). While the matrix of Equation (2) has fractional values, the matrix of Equation (1) consists of integer values, so that all mathematical operations are performed in integer math.

As mentioned above, FIG. 2A shows the unique yellow (120) and blue (125) hue locations and the D axis. Colors on the D axis are perceived as neutral by Deuteranopes. The blue primary is placed on the alychne. Points on the alychne have no luminosity. They are purely chromatic and non-luminous stimuli. Therefore, changes in the blue primary result in a change of the white point but produce no change in either the A or Y tristimulus values.

The location of the blue primary simplifies illuminant correction in digital photographs. The loci of the D illuminants over the range of color temperatures of 4,000 to 20,000 degree Kelvin are shown in FIG. 2A. The D illuminants lie on or close to the yellow-blue axis. Therefore, an adjustment of the blue primary's output is all that is required to change the color temperature of a reproduction.

The T axis of the ATD system lies on the line that passes thru the unique red and green hues as shown on FIG. 2. Tritanopes will interpret all colors that lie on this line as neutral. FIG. 2A shows both axes and the D illuminant data. This figure yields the surprising result that the axes intersect at the chromaticity coordinates of the D65 illuminant. This suggests that illuminant D65 is the natural set point for white.

The red and green primary selection is more complicated. These primaries lie on a line that is parallel to the D axis. This is done to approximate the behavior of the tritanopic system. The line is also constrained to pass thru the spectrum locus at 575 nm. This provides compact support for colors in the red-green region. The primary separation and location on the red-green line is selected so that the IQRGB color space provides compact support for the most saturated colorants found in nature and industry. The gamut of these colors 115 is called the Real World.

The red and green primaries are adjusted to simultaneously provide a compact support for the Real World and produce a uniform color space. In addition, the matrix relation between IQRGB, CIEXYZ and the relationships and positions of the primaries are not arbitrary. ATD is created so that the luminosity function, A, of the ATD color space is proportional to Y of CIEXYZ. The resulting IQRGB-ATD color space is described below.

The relationships shown in Equations (1) and (2) assume a D65 white point and that (RGB)=(1, 1, 1) transforms to (XYZ)=(0.9501, 1.000, 1.088). The matrices given in Equations (1) and (2) define the primaries. In an exemplary implementation, the red primary is located at CIE (x, y) coordinates (0.7844, 0.3128), the green primary at (0.2602, 0.6650) and the blue primary at (0.0267, 0.0000).

FIG. 2C is a graphical diagram illustrating the CIE 1931 spectrum locus as transformed and displayed as a function of the t and d chromaticity coordinates;

FIG. 2D is a graphical diagram illustrating an exemplary set of ATD color mixing functions. These are computed using Equation (2). The figure shows that the mixing function for the achromatic vector, A, is scaled four (4) times that used for CIE Y. The factor of 4 is chosen to increase the precision of the integer math calculations to 10 bits and; this eliminates the need for a compressive transformation of brightness. The diagram also shows that the transformation has kept the neutral points of the T and D vectors. The T color mixing function is zero at 475 and 575 nm where the T vector crosses the D axis. In similar fashion, the D color mixing function has no value at 500 nm where the D vector crosses the T axis.

The ATD tristimulus values are used in image manipulation to change tone scale or color balance. Rendering the image requires transforming the physical values to an appearance space. The next section of this application discusses the development of a uniform color space. The appearance space maintains the same integer math and simple calculations, as did the definition of the ATD tristimulus values.

### Characteristics of the Qtd Chromaticity Space

The ATD color space may then be transformed into a perceptual color space, defining a brightness component “Q”, and two chromaticity coordinates “t” and “d”. More specifically, the brightness component “Q” is importantly and significantly defined to be non-linear with respect to luminosity (“A” or “Y”), to account for the differences in perceived brightness for colors having the same measured luminosity. As a consequence, the brightness component “Q” is defined as:

Q=A+T/2−D, if D>0, and

Q=A+T/2−3D/4, otherwise.

with chromaticity coordinates “t” and “d” defined relative to “Q”, as t=T/Q and d=D/Q.

As indicated above, while the present invention is not limited to the ATD color space or the Qtd perceptual color space coordinates, there are particular advantages to use of these tristimulus values and resulting Qtd perceptual color space coordinates. Importantly, the ATD color space provides a compactness (i.e., a compact algebraic support), tightly enclosing all real world colors; as a consequence, digital representations having a limited number of bits (e.g., 8 bits (one byte)) can represent more colors, providing more fine-grained and thereby more accurate color designations, as bits are not wasted on non-reproducible or non-existent colors (i.e., those tristimulus values within CIE XYZ or other color spaces which are outside the observable color range and do not represent actual or humanly-perceptible colors).

Preliminary research shows that the chromatic channels' influence on the achromatic channel plays a large role in producing a uniform chromaticity space. Trial chromaticity coordinates are computed by dividing the T and D tristimulus by a normalization factor. This factor is determined by using arbitrary integer multipliers to modify the A, T and D vectors. The magnitude of the normalization factor is found to be a function of hue when the model coefficients are adjusted for best fit to large and small color difference measurements. The spectral shape of the normalization factor is similar to that of the Helmholtz-Kohlrausch, (H-K), effect (Wyszecki, 1982b).

The H-K effect or luminance additivity failure is well known. Highly chromatic colors usually appear brighter than the luminance value predicted by CIE Y. The model used in this paper assumes that the T and D channels of vision are either adding to or subtracting from the brightness of the A channel. Sanchez and Fairchild (2001) have measured the H-K effect for very chromatic colors. They use a monitor in their experiment to produce bright and highly chromatic samples.

FIG. 3 shows another significant feature of the ATD color space, namely a more evenly distributed color space, with perceptually equal differences in color being able to be represented in approximately more equal increments. FIG. 3 is a graphical diagram illustrating Munsell colors, which are perceptually equally spaced in hue and chroma, as mapped to a CIE XYZ color space and to an exemplary ATD color space. Colors with perceptually equal increments of hue would ideally manifest as equally spaced points around a circle in chromaticity space for constant chroma. Similarly, colors with perceptually equal increments of chroma would ideally manifest as equally spaced points along radii in chromaticity space for constant hue. The greater uniformity of the ATD color space compared to the CIE XYZ color space is evident. This more equal distribution provides an additional advantage, namely, the ability to interpolate between values to provide perceptually accurate results.

Yet another advantage, defining ATD as RGB increments (illustrated above) further allows mathematical calculations to be performed without floating point arithmetic, allowing faster computation. As a given image may have a hundred million pixels, for example, this computational savings directly results in significant time savings, particularly important for consumer applications. It will be apparent to those of skill in the art that any tristimulus system may be converted equivalently into ATD values in such a way as to avoid any need for floating point arithmetic, such as through appropriate scaling.

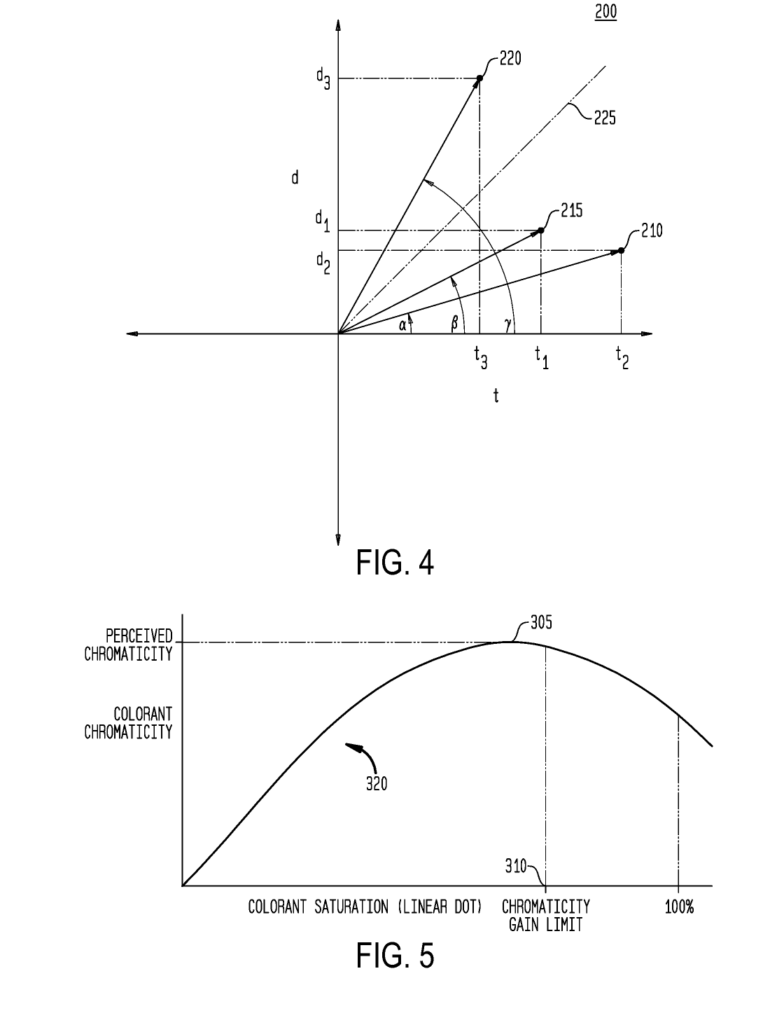

FIG. 4 is graphical diagram illustrating a plurality of exemplary vectors within a “td” chromaticity coordinate system 200 in accordance with the teachings of the present invention. Referring to FIG. 4, a first selected hue having a selected saturation level (at point 210) may be uniquely defined by its corresponding t and d coordinates, with the first selected hue (at point 210) having t₂ and d₂ coordinates. The ratio t/d defines a unique hue, with the magnitude of the distance from the origin defining the saturation level of the unique hue. It will be apparent to those of skill in the art that this use of the ratio t/d also simplifies calculations, as trigonometric calculations may be avoided.

More specifically, the ratio t/d can be utilized to define a hue angle (e.g., hue angle α corresponding to t₂/d₂) corresponding to the selected hue, with the hue angle represented by its direction cosines, namely, the corresponding t₂ and d₂ values for this example. As illustrated, a second selected hue (at point 215) has a different hue and less saturation than the first selected hue, while a third selected hue (at point 220) also has a different hue and more saturation than either the first selected hue or the second selected hue. In addition, as the ratio t/d changes, it is indicative of visual attention changes; for example, as hues may transition from a point on the t-axis to a point on the d-axis (around the line 225 (where t=d)), a “tipping point” occurs, with attention being drawn to the more active opponent channel mechanism, either t or d. Regardless of how the ATD values are determined, such as by original generation or translation (transformation) from RGB or CIE XYZ, for example, the resulting ATD values will be utilized as an “index” into an exemplary color management model of the present invention. In an exemplary embodiment, the color management model of the present invention may be represented in a relational database as a series of database tables, as discussed above. The ATD values (or, equivalently, Qtd values) provide an index to such tables, which then provide corresponding output values utilized to drive or command a corresponding output device, such as a printer, a printing press, a display, or monitor. As a consequence, in sharp contrast to the prior art, the color management model of the present invention is independent of any output device. Measurements of a selected output device are utilized, however, to provide corresponding output values from the color management model such that the selected output device provides a corresponding, perceptually accurate image within the confines of the color gamut the selected output device is capable of producing.

The exemplary color management model of the present invention utilizes 256 different hues, having 192 (0 to 191) states of color saturation, and for each hue and saturation combination, 1020 levels of gray. This provides approximately 46 million states of the exemplary color management model, which is considered empirically sufficient for virtually any imaging situation. Once an input image is modeled using this rich ATD color space, this input image does not need to be changed to be output on different devices; for example, a graphical image suitable for output on a first printer does not need to be “repurposed” for output on a second printer. Rather, the ATD values for the selected input image remain static and provide the same index values into the color management model, referred to as a “meta printer.”

This “meta printer” creates a model of a theoretically unlimited or ideal output device, which (through stored database values) will then be translated to calibrated values for a selected output device (which generally is not an ideal device and has typical printer limitations, such as a limited gamut) and based upon selected media (which may have brightness/darkness limitations, for example. The exemplary color management model then provides an output corresponding to the selected printer, based upon empirically determined, measured (or calibrated) values of the corresponding output device. As a consequence, once a selected output device has been calibrated, no images need to be repurposed for image reproduction on the device, with all such translation accomplished via the “meta printer”, using database tables to translate the image to the calibrated values of the output device.

The exemplary color management model of the present invention provides an “appearance transform” which utilizes and combines three separate models, namely, a linear chromaticity gain model, a (nonlinear) combined darkness and brightness model, and a neutral value model. These models are utilized to form a “translator”, from the idealized “meta printer” to any selected output device, which will translate any image (specified in ATD, RGB or XYZ, for example) to the selected output device, utilizing the color modeling and management of the present invention, to provide a perceptually accurate image reproduction. This modeling will be perceptually accurate, and may not be calorimetrically accurate. The ATD color space for the translator is populated by measuring and empirically determining values for the brightest available colors for the model. The brightest of each selected hue and saturation is referred to as “Q_{TOP}”. These values are then proportionally darkened, to create the balance of the color space. In an exemplary embodiment, the Ektachrome colors and standard lithographic colors were examined to provide such brightness values, and to create empirical formulas for converting RGB or XYZ values into the ATD color space.

The exemplary chromaticity gain model of the present invention is illustrated in FIGS. 5-7. FIG. 5 is graphical diagram illustrating an exemplary chromaticity gain limit in accordance with the teachings of the present invention. As illustrated in FIG. 5, chromaticity initially increases with saturation (measured as a linear dot percentage), in region 320. This increase may or may not be linear; in accordance with the exemplary embodiment, such applied percentages are calibrated to achieve linear increments of chromaticity. Depending upon the ink, such as cyan or magenta, as the saturation approaches the range of 70% to 80% (in general), the perceived chromaticity will reach a maximum (305). Thereafter, increasing the amount of ink applied (as an increased percentage of linear dot) does not result in an increase in perceived chromaticity, and may even result in a decrease in perceived chromaticity, as the image may begin to grey or get darker rather than more chromatic. As a consequence, the chromaticity gain model of the present invention creates a linear chromaticity scale, and limits applied ink or pigment to the level at which the perceived chromaticity is at a maximum (and possibly slightly greater than this maximum), resulting in a chromaticity gain limit (310).

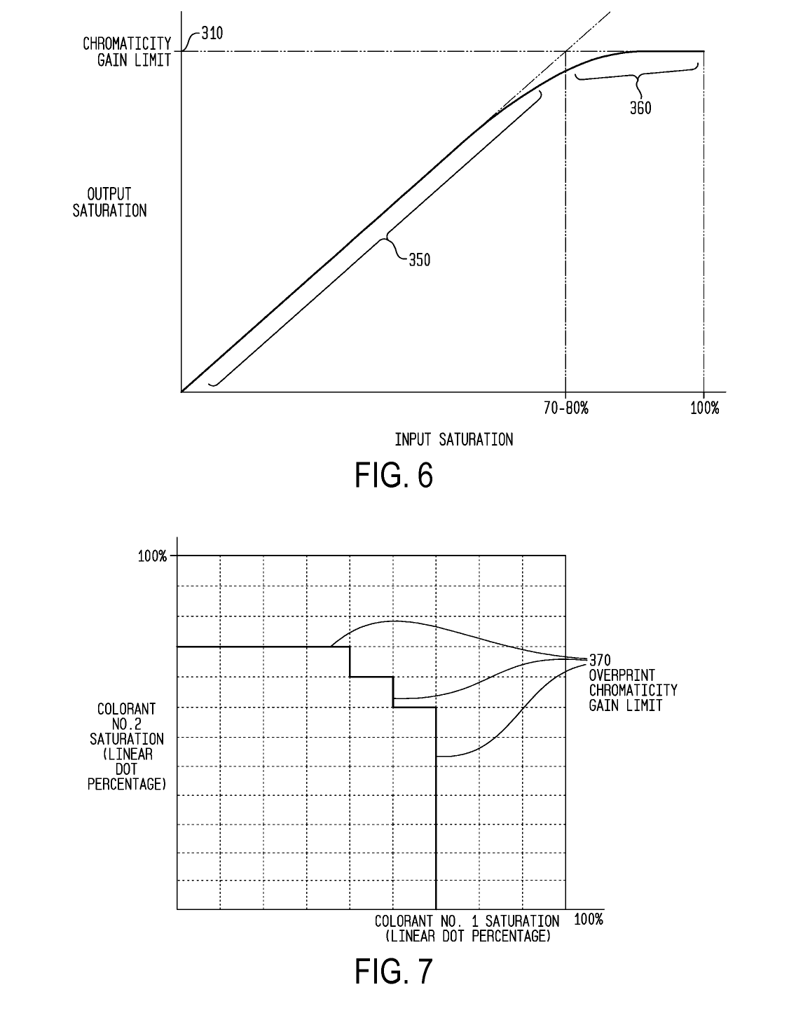

FIG. 6 is graphical diagram illustrating an exemplary saturation (chromaticity gain) compander in accordance with the teachings of the present invention, which maps input saturation (such as from an input RGB or XYZ image), to output saturation (or chromaticity), to drive an output device such as a printer. As illustrated in FIG. 6, until the vicinity of the chromaticity gain limit 310, the chromaticity gain model provide a generally linear, one-to-one mapping of input saturation to output saturation (350), typically measured as linear dot percentage. Such linearity may also require calibration of the output device, to the extent the resulting chromaticity increments are not a linear function of colorant percentages (increments). As the input saturation approaches and then exceeds the chromaticity gain limit, the chromaticity gain model will limit (or compand) the output saturation to the chromaticity gain limit (360), resulting in input values (or states) being compressed to fewer output values (or states) for higher saturation levels. As indicated above, depending upon the selected output device and inks/pigments utilized, for example, the chromaticity gain limit generally will be at approximately 70-80% linear dot. As mentioned below, this companding to a chromaticity gain limit applies to each hue, which may be a primary or secondary colorant or a hue generated as a combination of primary or secondary colorants, typically as overprints.

More specifically, this chromaticity gain limit is also applied to colorant combinations, which are generally applied as overprints of one primary or secondary colorant over another primary colorant. FIG. 7 is diagram illustrating an exemplary overprint chromaticity gain limit 370 in accordance with the teachings of the present invention. Input-to-output saturation companding for overprints is also utilized, as previously discussed above with reference to FIG. 6. More specifically, such companding is provided for each hue, usually as a combination of two or more primary colors, such that at higher saturation levels, more input states or values are translated to fewer output states or values, as illustrated in region 360 of FIG. 6.

In addition to significant ink savings, this chromaticity companding has the added value of moving the potential for reproduction error into imperceptible image regions. It further allows groups of output devices to be calibrated statistically, requiring less operator input and, in many instances, less required printing control, particularly for presses.

In exemplary embodiments, such companding may be digitized and stored in tables of a database, as mentioned above. For example, each hue may be mapped to a saturation index of a table, which will then provide the corresponding chromaticity level required, as calibrated for the selected output device.

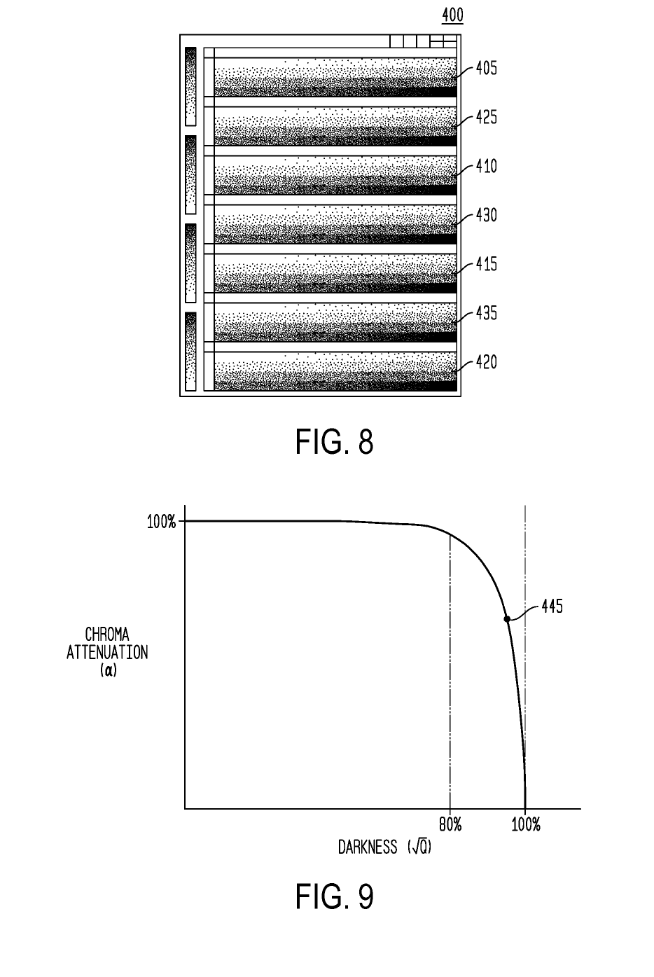

FIG. 8 is an exemplary 100-step chart 400 for color management system linearization in accordance with the teachings of the present invention, typically as applied to output print devices. The chart 400 is an example and for purposes of illustration for an exemplary CMYK system and may be extended to systems having additional or different colorants; those of skill in the art will recognized that a myriad of equivalent charts are available and may be utilized equivalently.

Typically in graphic arts systems, the dot gain or tone value gain of the cyan, magenta, yellow and black inks for a CMYK system is determined as a function of the tint value provided (input) to the press, as a typical press generally prints a slightly greater tone value than the input tone value. The mid tone gain of most presses is about 15 percent. The color management system of the invention will also compensate for the output device tone gain for each color. The 100-step chart 400 allows the color management system to first linearize the output device (printer system) with respect to saturation (tone value) (i.e., linearize chromaticity as a function of applied colorant). Then, as discussed above, the color management system then provides a second step, in which the linear tone scaled data is converted to chromaticity and plotted as a function of the tone value, as illustrated in FIG. 5, to determine the chromaticity gain limits for the primary and overprint colors. At or near the peak (chromaticity gain limit), the color management system will limit the amount of ink that will be used to further calibrate the output device, such as a printer.

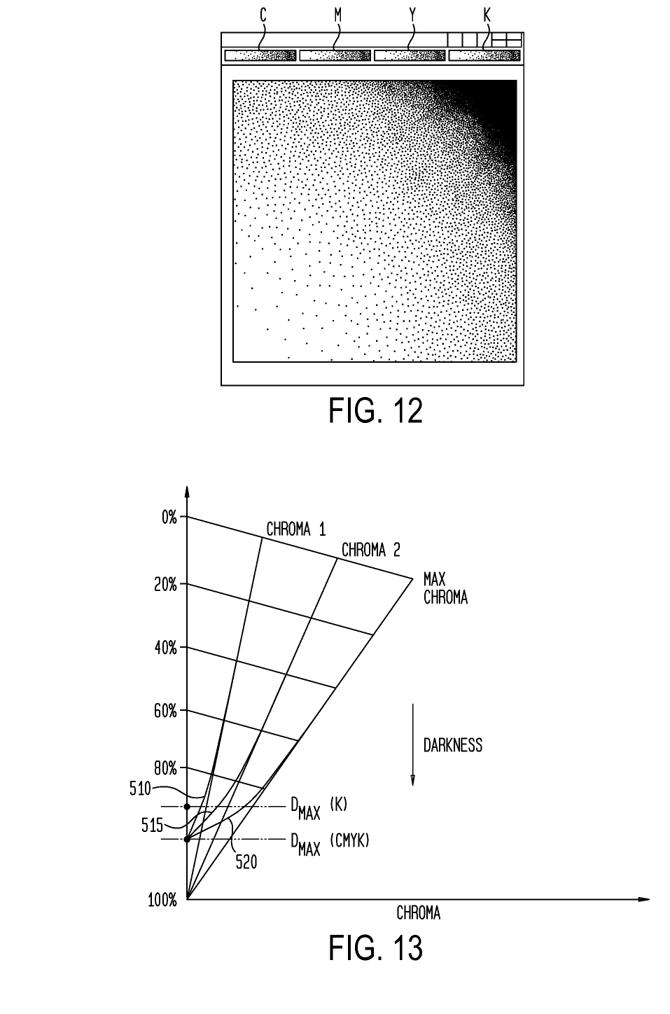

As illustrated in FIG. 8, the 100-step chart 400 is a set of long step wedges or ramps, one for each of the colors cyan (405), magenta (410), yellow (415), black (420), and the overprint colors blue (425), red (430), and green (435). The reflectance output values are then read utilizing a spectrophotometer, as known in the art, generally in 10 nm increments, and can then be utilized to calibrate the output device and to determine corresponding chromaticity gain limits for the selected output device, in addition to any shift in hue angle, and to correct for any nonlinearities in chromaticity as a function of applied colorant (dot percentages). These selected chromaticity gain limits of the selected output device may be linearly correlated with the chromaticity gain model of the color management system, such that each linear chromaticity increment of the chromaticity gain model is matched to corresponding increments of the selected output device. In addition to the 100-step chart as illustrated, a randomized version may also be produced and measured, in order to cancel out within sheet variability of measured values. Additional calibrations are discussed below with reference to FIGS. 12 and 15.

This linear chromaticity gain model, with the chromaticity gain limits determined for the selected output device, is one of several new and novel features of the present invention.

The exemplary combined darkness and brightness model of the present invention is illustrated in FIGS. 9-12. FIG. 9 is graphical diagram illustrating an exemplary chroma reduction and convergence to black chromaticity point 445 in accordance with the teachings of the present invention. As illustrated in FIG. 9, in darkening colors in accordance with the invention, chromaticity is not reduced substantially until darkness exceeds a predetermined level, illustrated as convergence to black chromaticity point 445. Also as illustrated, darkness values are measured using a brightness (Q) scale of the present invention (and not CIE Y), and may be in increments of Q or, as illustrated, in increments of the square-root of Q (Q^{1/2}), as brightness differences tend to be perceived as a function of the square-root of brightness Q. The chroma attenuation may be designated by a variable “α”, which will be utilized as an attenuation factor for the amount of C, M or Y utilized for a given pixel (discussed in greater detail below, following the discussion of FIG. 15).

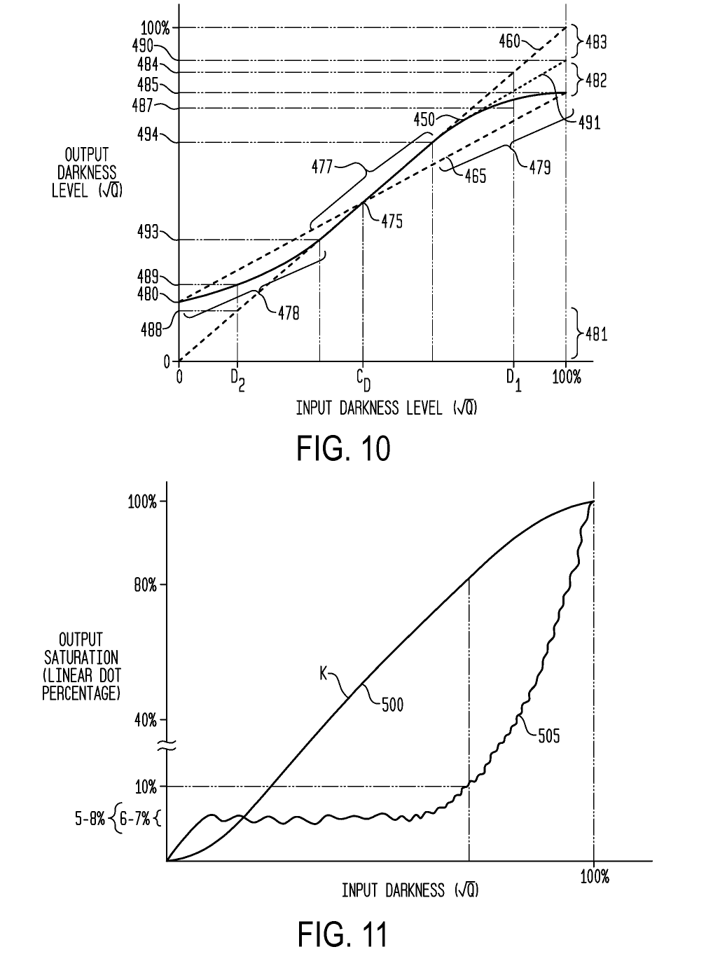

FIG. 10 is graphical diagram illustrating an exemplary darkness and brightness model (or, equivalently referred to as a darkness and saturation model) in accordance with the teachings of the present invention, and illustrates its nonlinearity. Ideally, an input darkness would be identically mapped one-to-one to an output darkness, illustrated as dashed line 460 having a slope equal to one. Various colorants, inks, displays, and so on, however, generally have a maximum darkness on a given medium or substrate, which is not as dark as an absolute blackest black. Similarly, media or substrates, such as paper used for printing, is not as bright as an absolute whitest white. For example, displays and substrates such as paper have a maximum brightness (illustrated as point 480), providing a minimum darkness level, with papers such as newsprint having considerable more darkness than typical white bond paper, for example. In addition, even various white bond paper substrates have different brightness levels. Similarly, maximum darkness is also limited, such as based upon selected inks and types of displays, illustrated as a maximum darkness 485 (for a black ink) and a maximum darkness 490 (for CMY combinations). In addition, as discussed in greater detail with reference to FIG. 11, black inks often have a level of transparency, limiting their ability to provide complete darkness. As a consequence, various specified darkness and lightness values will be out-of-gamut for selected output devices and/or colorant and substrate combinations, such that very light and very dark colors may not be achievable directly, illustrated as brightness out-of-gamut region 481, and darkness out-of-gamut regions 482 (black) and 483 (CMY combinations).

Another new and novel feature of the present invention allows for images to “appear” to be both lighter and darker than these maximum lightness and darkness values, using the combined darkness and brightness model of the invention. An exemplary nonlinear mapping of the combined darkness and lightness model is illustrated as the s-shaped (sigmoidal) line 450 in FIG. 10, and may be generated numerically or utilizing any of a plurality of curve-fitting algorithms (such as a 2-part curve-fitting algorithm). In addition, a plurality of sigmoidal curves are equivalently available, and any given sigmoidal curve may be selected based upon empirical results or individual preference. As illustrated, a line 465 between the minimum darkness (maximum lightness) (480) and maximum darkness (485) values will intersect the (ideal) line 460, illustrated as point 475, where the original (input darkness value) and the reproduction (output darkness value) will have the same density and apparent brightness, and the mid-tone of the original is preserved. This intersection point will vary in location depending upon the substrates (maximum brightness (minimum darkness)) and colorants/blacks utilized or otherwise available.

At point 475 and its vicinity, namely, for input darkness below a first predetermined level 494 and above a second predetermined level 493, the slope of the combined darkness and brightness model will be about 1, providing a linear region 477 for mapping of input to output darkness. For an increased perception of brightness, the model of the invention converges (and compands) the comparatively lower darkness values nonlinearly toward the maximum brightness value 480, illustrated as nonlinear region 478, for both black and CMY values. Similarly, for an increased perception of darkness, the model of the invention converges (and compands) the comparatively greater darkness values nonlinearly toward the maximum black darkness value 485, illustrated as nonlinear region 479, for black, and increases color (CMY) combinations approximately linearly to the maximum color darkness value 490, illustrated as linear region 491 (dotted line). (The addition of small amounts of color are discussed in greater detail below with reference to FIG. 11, and is referred to as approximately linear, as the black and neutral model includes a comparatively small oscillation or dithering of the CMY or other colorant values). Using this combined darkness and brightness model, images are actually perceived to be lighter and to be darker than they really are, as determined by measured luminosity.

More specifically, an output darkness level may be determined for a plurality of colorant values for reproduction of an image on an output medium having a minimum darkness (480), with the reproduction having a maximum black colorant darkness (485) on the output medium. When an input darkness of a selected pixel of the plurality of pixels is greater than a first predetermined darkness level (494), the output black darkness of the selected pixel is constrained to a value less than or equal to the lesser of the input darkness (illustrated by line 460) and the maximum darkness (485), illustrated as region 479. Similarly, when the input darkness of the selected pixel is less than a second predetermined level (493), the output black darkness of the selected pixel is constrained to a value greater than or equal to the greater of the input darkness and the minimum darkness (480), illustrated as region 478. As illustrated, the constraining of the output black darkness is substantially nonlinear, and is typically the “S” portion of a sigmoidal shaped curve or mapping. When the input darkness of the selected pixel is not greater than the first predetermined darkness level (494) and is not less than the second predetermined darkness level (493), the output black darkness of the selected pixel is determined as a substantially linear mapping from the input darkness, illustrated as region 477.

As mentioned above, this nonlinear combined darkness and lightness model is one of the truly unique features of the present invention, and is applied to each hue of the ATD color space, providing the capability to darken and brighten each individual pixel of a selected image. In addition, as illustrated, the nonlinear compander (illustrated as line 450) also compensates for the darkness of the substrate, allowing images to appear to be lighter than the surrounding medium. As a consequence, in exemplary embodiments, the combined darkness and brightness model is then adapted for selected substrate (e.g., paper) and ink combinations, for example, when utilized to drive a printer as an output device.

As an example, continuing to refer to FIG. 10, the comparatively greater darkness level of D₁, which would ideally map to a darkness level (484) if a complete range of darkness values were available (on line 460), is instead mapped to a darkness level (487, from line 450) which is less than the maximum available darkness level (of 485), even though the maximum available darkness is closer to the ideal darkness level. Similarly, also as an example, the comparatively lesser darkness level of D₂, which would ideally map to a darkness level (488) if a complete range of darkness or brightness values were available (on line 460), is instead mapped to a darkness level (489, from line 450) which is actually darker than the minimum available darkness level (of 480), even though the minimum available darkness is closer to the ideal darkness level.

The black and neutral models of the present invention are also unique. In accordance with the present invention, it is no longer necessary to utilize a large amount of cyan, magenta and yellow ink to produce neutral colors in an image or to darken the image. Rather, the black and neutral models primarily utilize black to generate blacks, grays and other neutrals, and utilize small amounts (generally about 7% or less, except for very dark grays and blacks) of CMY or other colorants in various combinations to generate fine gradations (and interpolations) between the levels obtainable by using degrees of black. Also illustrated above, the combined darkness and brightness model is utilized to provide the darkening or lightening of the color in each pixel of the image.

In addition, black tones also utilize very little of the colored inks. Small amounts of colored inks such as CMY are used instead to create a much finer long range gray scale than is possible with traditional separation methods. This use of small amounts of the colored inks removes the problems of image interaction and light source dependence (metamerism). This small use of colored ink also removes the need for careful color balance and eliminates the long runs of wasteful testing runs. The change of the paradigm in producing neutral colors leads to a great savings in paper and ink. As mentioned above, the combined darkness and lightness model takes into account the requirement for using small amounts of cyan, magenta and yellow inks to produce the fine neutral scale.

FIG. 11 is graphical diagram illustrating an exemplary output (as colorant (ink) percentages) for black (combined brightness and darkness) and neutral models in accordance with the teachings of the present invention. As illustrated, the vast majority of darkening utilizes a black ink, as illustrated on line 500, and is nonlinear to the extent discussed above for the darkness/brightness model. As mentioned, black is utilized primarily to create the grays and neutral tones, with comparatively small amounts of cyan, magenta or yellow utilized to create finer gradations in the gray/neutral scale, essentially creating interpolations between the gray and black levels obtained through the use of black alone. Line 505 graphically illustrates the amounts of colorants (e.g., cyan, magenta, yellow or other primary or secondary colorants) which are then included in selected combinations with the black ink, to produce the final darkened image.

As illustrated, to provide both darkening and neutral tones, small amounts of CMY (or other colorants) are utilized, increasing linearly to a first predetermined level of approximately 6 or 7% (linear dot output), to provide neutral tones and darkening. With increasing input darkness, the CMY output is maintained in the vicinity of 6 or 7%, with significantly increasing amounts of black. The amounts of CMY are “dithered” or oscillated slightly around this 6-7% range, providing additional gradations of neutral tones (and a gray scale with 1020 levels). To provide neutral tones having darkness levels of 10% and higher, CMY amounts are only quadratically (approximately, with some oscillation/dithering) increased above this first level, with the maximum level of CMY selected depending upon the maximum level of colorant usage (output) which may be selected, and may range from approximately 40% to 100% utilized for 100% darkness. In addition, the amount of colorants utilized, such as CMY, will vary based on the selected color model; for example, blackness may be achieved utilizing only a black pigment without other colorants, or may utilize one or more of the various colorants (such as CMY).

FIG. 12 is diagram illustrating an exemplary neutral model in accordance with the teachings of the present invention. As illustrated in FIG. 12, the vertical axis defines increasing levels (percentages) of black colorant (ink), while the horizontal axis defines changing CMY values, where each CMY combination maintains gray balance. This results in the exemplary 1020 levels of gray, which are substantially spectrally flat, using all combinations of K and CMY steps in small step increments. In exemplary embodiments, FIG. 12 may be utilized as a target for neutral calibration of the selected output device, following gray (neutral) balancing of the selected output device (i.e., gray balancing to determine the comparative amounts of CMY to provide selected gray, neutral increments).

This neutral and black model of the present invention is in sharp contrast with the prior art, in which neutral and black utilize CMY levels in the ratios of 100:80:80, respectively, at all levels of darkness, which contributes substantially to strong metameric effects (as the prior art neutrals are not substantially spectrally flat). In addition, in accordance with exemplary embodiments, where possible, only 2 of the 3 CMY are utilized for or in the chromatic portion of the image before the addition of a darkness component, to further decrease metameric effects. In addition, this use of small amounts of CMY reduces the need for gray and neutral balancing in commercial printing and graphic arts applications.

FIG. 13 is graphical diagram illustrating an exemplary chroma reduction for a darkness model in accordance with the teachings of the present invention, and provides a graphical illustration and a partial summary of the discussion above. As previously mentioned, with increasing darkness, additional black is utilized. To maintain saturation and hue, albeit darkened, chroma is substantially maintained while darkened. As illustrated for chroma 1 (line 510), chroma 2 (line 515) and maximum chroma (line 520) in FIG. 13, chroma is not reduced significantly until approximately 80% to 90% darkness is required. In addition, even for maximum chroma, substantial chroma is maintained until darkness levels approach approximately 95%. This maintenance of chroma solves the problem of a loss of colorfulness in images typically found in systems utilizing gray component replacement (GCR) or other color removal (UCR).

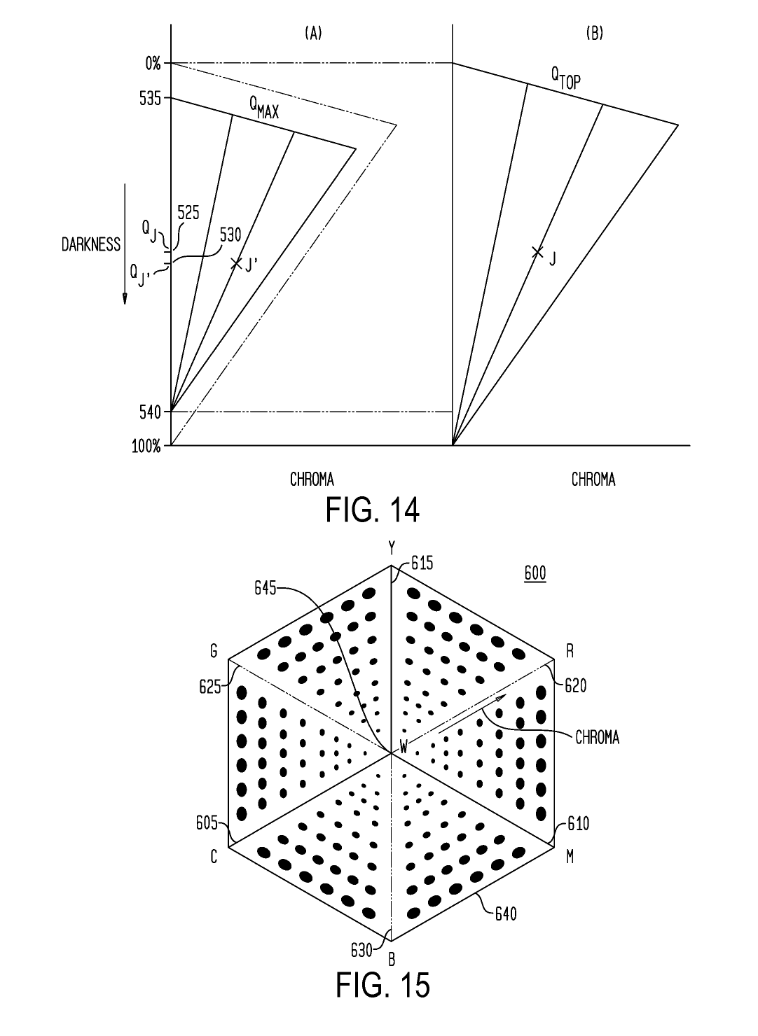

As mentioned above, there may be instances where the selected output device does not provide for the full gamut or range of hues, brightness and darkness levels available in the ATD or other color gamuts. As a consequence, in accordance with the present invention, the same proportions of hue, brightness and darkness are generally maintained (except in the nonlinear brightness and darkness regions discussed above). More specifically, the same ratios with respect to the brightest available hues (Q_{TOP}) are maintained in an out-of-gamut mapping. FIG. 14 is a diagram illustrating exemplary proportional out-of-gamut companding in accordance with the teachings of the present invention. The right (B) side of FIG. 14 illustrates the brightness gamut for a selected hue in the full ATD color space, while the left (A) side illustrates a more constrained gamut for the selected hue, having a lower brightness 535 (Q_{MAX}) and less darkness 540 available. As illustrated in FIG. 14, rather than preserving a particular luminance or brightness level, a selected hue having a particular brightness level (Q_{J}) 525, illustrated as “J” in the right (B) side of FIG. 14, is ratiometrically mapped to “J′” having a particular brightness level (Q_{J′}) 530 in the left (A) side of FIG. 14. In this gamut mapping, the same chroma is maintained, and the brightness ratios between the gamuts are maintained, such that Q_{J}/Q_{TOP}=Q_{J′}/Q_{MAX}. This is in sharp contrast with the prior art, in which the same luminance values would be maintained but chroma would be reduced, such as in Granger U.S. Pat. No. 5,650,942, issued Jul. 22, 1997.

As previously discussed with reference to FIG. 8, a selected output device is calibrated, to determine its chromaticity gain limits, and in exemplary embodiments, to linearize chromaticity increments as a function of applied colorants (such as linear dot percentages). In addition, the brightest hues available for the selected output device are also determined and measured, to determine Q_{MAX} for each available hue. In exemplary embodiments, a hex chart 600 such at that illustrated in FIG. 15 is utilized for this brightness calibration, at maximum available brightness levels, with increasing chroma (saturation) toward the periphery 640, as illustrated using successively larger (heavier) dots. As illustrated, the hex chart includes available hues as CMY combinations at various saturation levels, with the brightest available white 645 at the center, with three axes representing cyan (605), magenta (610) and yellow (615), and 3 axes representing the red (620), green (625) and blue (630) overprint combinations. Measurements are performed in equal chromaticity increments, with linear interpolation between measurements.

The resulting measurements and interpolated values are utilized to populate the various tables for the selected output device, resulting in a plurality of ATD, XYZ or RGB hue and saturation values which are calibrated for the output device. As indicated above, any such XYZ or RGB values may be readily converted into ATD or Qtd values, as may be necessary or desirable. Once calibrated, ATD or Qtd values may be utilized as an index into the calibrated table, which then provides output values of the CMYK values needed to drive the output device (and result in the selected ATD or Qtd values of the reproduced image). The Q_{MAX} values are then available for comparison with Q_{TOP} of the models and utilization in the various ratiometric determinations.

As mentioned above, input tristimulus values, such as RGB, CIE XYZ, ATD, or Qtd, in the exemplary embodiment, are utilized as indices to database lookup tables, which are configured or populated in advance with output data which has been calibrated for the selected output device and which have been modified in advance by the various models of the present invention. As a consequence, a set of tristimulus values for a selected pixel provides an index (or CAM, for content addressable memory) for one or more database tables. The output from the tables are a plurality of colorant values (such as exemplary CMYK values) for the pixel. In exemplary embodiments, the output values for the pixel have the following form, illustrated with respect to an exemplary CMYK system:

C_{OUT}=α_{C}(H,S)+C_{DARK}(Q/Q_{TOP});

M_{OUT}=αM(H,S)+M_{DARK}(Q/Q_{TOP});

Y_{OUT}=α_{Y}(H,S)+Y_{DARK}(Q/Q_{TOP}); and

K_{OUT}=K_{DARK}.

For example, the output cyan (or magenta or yellow, respectively) is specified by the cyan (or magenta or yellow) levels from a hue and saturation index, as attenuated by any “α” (FIG. 9), and as adjusted by the darkness/brightness model. The output black is provided by the darkness/brightness model, as illustrated in FIG. 10.

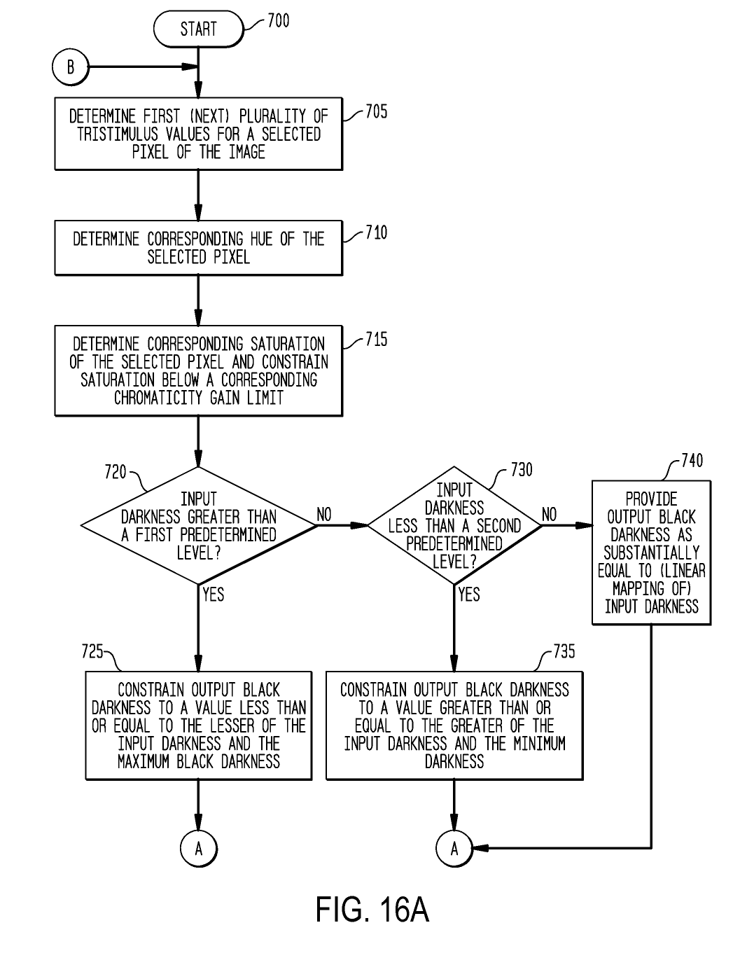

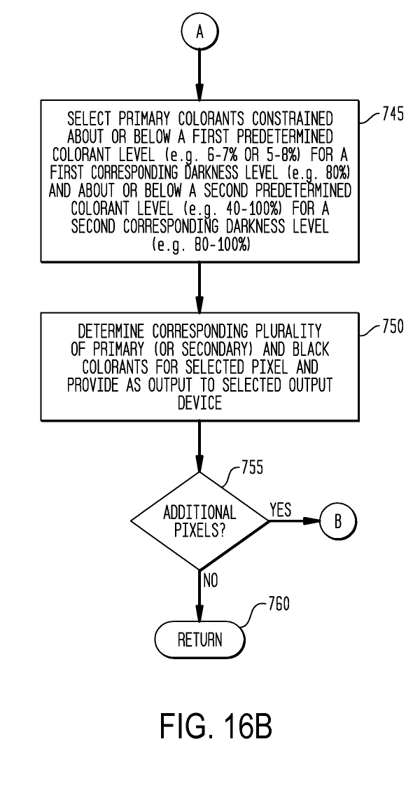

The various color management models of the present invention, such as the chromaticity gain model, the darkness and brightness model, and the neutral model, may be embodied in any of a plurality of forms, such as in software and database tables (e.g., relational database tables), as discussed above. FIGS. 16A and 16B, taken together, provide a flow chart for determining colorant values for the color management methodology in accordance with the teachings of the present invention, and may be embodied as software, for example, and provides a useful summary of the inventive features of the exemplary embodiments.

Referring to FIGS. 16A and 16B, a computer-implemented method of determining colorant values for reproduction of an image begins, start step 700, with providing or determining a first plurality of tristimulus values for a selected pixel of the image, step 705. The plurality of tristimulus values are generally at least one of the following types of tristimulus values, such as CIE XYZ, CIELAB, RGB, ATD, or Qtd. The plurality of tristimulus values may be determined as an input of a corresponding plurality of digital values from a scanned image, from a digital photograph, or from a digital graphics image. In addition, the plurality of tristimulus values may be converted, for example, from RGB or XYZ to ATD or Qtd. Next, in step 710, a corresponding hue is determined for the selected pixel, which may be specified, for example, utilizing t or d chromaticity coordinates. In step 715, a corresponding saturation for the selected pixel is determined, and is constrained to be below a corresponding chromaticity gain limit.

The step of constraining the saturation below the corresponding chromaticity gain limit is based upon determining the corresponding chromaticity gain limit as a maximum perceived chromaticity as a function of increasing colorant saturation, as discussed above with reference to FIGS. 5-7. Also as discussed above, the determination of the hue and saturation may be accomplished through a lookup table maintained in database 70 and indexed through the tristimulus values, such as the t or d chromaticity coordinates. In exemplary embodiments, the constraining or companding of the saturation (or chroma) to the chromaticity gain limit may be accomplished through the corresponding constraining of the saturation values input into and contained in the lookup table.

Next, a corresponding darkness is determined for the selected pixel, utilizing the darkness and brightness model of the invention. The method may include determining a maximum black darkness and determining a minimum darkness, such as the darkness/brightness of the substrate, and correspondingly constraining a black darkness of the selected pixel as illustrated in FIG. 10.

More particularly, in step 720, the method determines whether the input darkness is greater than a first predetermined darkness level (494). When an input darkness of the selected pixel is greater than the first predetermined darkness level in step 720, then in step 725, an output black darkness of the selected pixel is constrained to a value less than or equal to the lesser of the input darkness and the maximum darkness, generally nonlinearly as illustrated for region 479 in FIG. 10. When an input darkness of the selected pixel is not greater than the first predetermined darkness level in step 720, then in step 730, the method determines whether the input darkness is less than a second predetermined darkness level (493). When the input darkness of the selected pixel is less than a second predetermined darkness level in step 730, the output black darkness of the selected pixel is constrained to a value greater than or equal to the greater of the input darkness and the minimum darkness, step 735, generally nonlinearly as illustrated for region 478 in FIG. 10. When the input darkness of the selected pixel is not greater than the first predetermined darkness level in step 720 and is not less than the second predetermined darkness level in step 730, the output black darkness of the selected pixel is determined as substantially equal to the input darkness, step 740, generally linearly mapped as illustrated for region 477 in FIG. 10.

Following steps 725, 735 or 740, the method applies the neutral model of the invention, step 745, selecting primary or secondary colorants constrained at or below a first predetermined colorant level (e.g., 6-7% or 5-8%) for a first corresponding darkness level (e.g., 80%) and at or below a second predetermined colorant level (e.g., 40-100%) for a second corresponding darkness level (e.g., 80-100%). For example, the determination of the darkness for the selected pixel may further comprise selecting a darkness level provided as a black colorant having a saturation between about zero and one hundred percent and with a primary colorant providing less than a first predetermined level of saturation, such as about ten percent saturation, or alternatively, with a primary colorant providing less than about seven percent saturation. For greater darkness levels, the determination of the darkness for the selected pixel may further comprise selecting a darkness level provided as a black colorant having a saturation between about eighty and one hundred percent and with a primary colorant providing less than a second predetermined level of saturation, such as a second level between about forty to one hundred percent saturation. In addition, in selected embodiments, a darkness level may be provided as a black colorant and one or more of the primary colorants.

Next, in step 750, a corresponding plurality of primary and black colorant values are determined for the determined hue, saturation and darkness of the selected pixel, and may be provided as output to a selected output device. This step of determining the corresponding plurality of primary and black colorant values may further include substantially maintaining a chroma for the determined hue until the determined darkness is greater than about eighty percent. In addition, the step of determining the corresponding plurality of primary and black colorant values may include performing at least one database table lookup, with the database table containing a corresponding plurality of primary and black colorant values calibrated for a selected output device.

Following step 750, the method determines whether there are remaining pixels of the plurality of pixels, step 755; if so, the method returns to step 705. When there are no additional pixels requiring determination of colorant values in step 755, the method may end, return step 760.

The combined darkness and brightness model of the present invention may also be summarized as a computer-implemented method of determining an output darkness level for a plurality of colorant values for reproduction of an image on an output medium, where the output medium has a maximum black colorant darkness and a minimum media darkness, with the image having a plurality of pixels. As illustrated in FIG. 10, the method comprises constraining a black darkness of the selected pixel to a value less than or equal to the maximum black darkness when the darkness of a selected pixel of the plurality of pixels is greater than the maximum black colorant darkness; and when the darkness of the selected pixel is less than the minimum media darkness, constraining the black darkness of the selected pixel to a value greater than or equal to the minimum media darkness. In addition, when the darkness of a selected pixel of the plurality of pixels is not greater than the maximum black colorant darkness and is not less than the minimum media darkness, the model determines the black darkness of the selected pixel as a substantially linear mapping of an input darkness level.

The neutral model of the present invention may also be summarized as a computer-implemented method of determining a plurality of neutral gray values for reproduction of an image on an output medium, with the output medium having a maximum black colorant darkness. As illustrated in FIGS. 11 and 12, the method includes increasing a black colorant in linear increments to the maximum black colorant darkness to provide a plurality of black increments; maintaining a first plurality of primary colorants substantially at a first colorant level for each black increment of the plurality of black increments, where the first colorant level is typically between about 6 to 7 percent saturation; and combining the first plurality of primary colorants with the plurality of black increments to form a first plurality of neutral gray increment values. In addition, a second plurality of primary colorants is maintained substantially at a second colorant level for each black increment of the plurality of black increments, the second colorant level comparatively lower than the first colorant level, and with the second colorant level between about 5 to 6 percent saturation; and then combining the second plurality of primary colorants with the plurality of black increments to form a second plurality of neutral gray increment values.

A third plurality of primary colorants is maintained substantially at a third colorant level for each black increment of the plurality of black increments, the third colorant level comparatively greater than the first colorant level, for example, the third colorant level is between about 7 to 8 percent saturation; and then combining the third plurality of primary colorants with the plurality of black increments to form a third plurality of neutral gray increment values. In addition, for greater darkness levels, the model includes increasing a fourth plurality of primary colorants in substantially linear increments to a fourth colorant level to provide a plurality of primary colorant increments, the fourth colorant level comparatively greater than the first colorant level and the third colorant level, but typically less than 40-100 percent saturation; and combining the fourth plurality of primary colorants with a subset of the plurality of black increments, the subset of the plurality of black increments having corresponding black colorant levels greater than a predetermined threshold, such as 80%, to form a fourth plurality of neutral increments. Lastly, the neutral model combines the first, second, third and fourth plurality of neutral gray increment values to form the plurality of neutral gray values.

### Testing the IQRGB Model

The new RGB-ATD-Qtd model is compared with CIExyY and CIELAB to illustrate the ability of the model to predict a wide variety of vision data. All tests are made at a relative luminance CIELAB L* of 50.0 and a D65 white point. The H-K effect is already modeled in the development of the chromaticity space as discussed above.

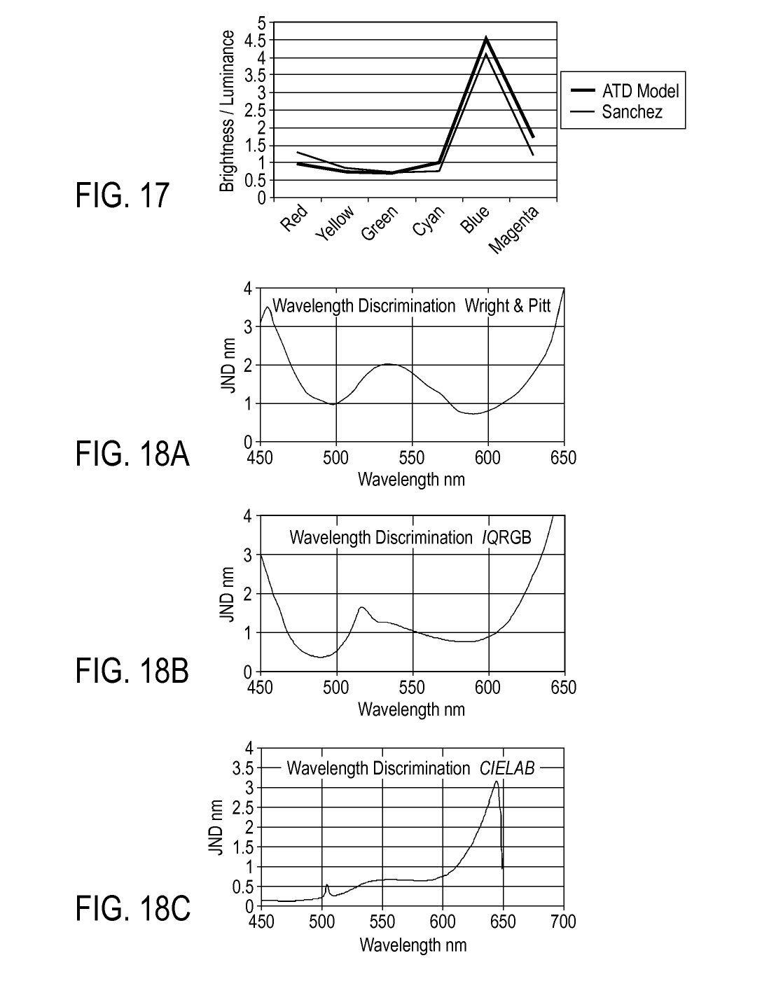

FIG. 17 shows the comparison of the spectral shape of the IQRGB normalization factor with that of the brightness-lightness ratios determined by the Sanchez-Fairchild research mentioned above with respect to the Helmholtz-Kohlrausch (H-K) effect (Wyszecki, 1982b). Note that the H-K effect is not modeled by either of the comparison spaces.

Although the Q model is very simple, it produces a good fit to the measured H-K effect. The brightness factor, Q, is used as the normalization factor in the definition of chromaticity. The model produces a very reasonable uniform chromaticity space for both large and small color difference data. The coefficients of the model for Q are constrained to be integers and are adjusted to best fit the Sanchez-Fairchild data.

Wavelength Discrimination

Wavelength discrimination is a test of the uniformity of the spaces for the most saturated color, those on the spectrum locus. FIG. 18A shows the wavelength discrimination data measured by Wright and Pitt (Wyszecki, 1982c).

Wavelength discrimination for IQRGB and CIELAB is modeled by transforming the CIE 1931 chromaticity diagram to (t, d) and (a*, b*) and taking the inverse of the distance between adjacent 1 nm points on the spectrum locus as shown on FIG. 2C. The just noticeable difference (JND) between points is scaled to match the known visual data. The IQRGB Qtd wavelength JND versus wavelength is shown in FIG. 18B and the CIELAB JNDs are displayed in FIG. 18C. The comparison of the curves on these three plots shows that IQRGB transformation best models the known wavelength data.

Large Color Differences

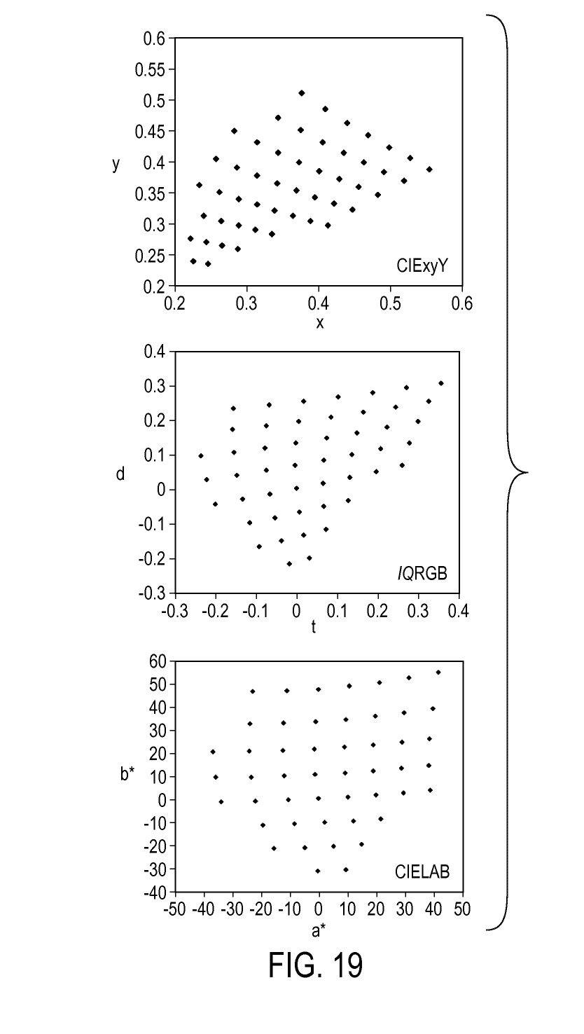

The uniform color scales of the OSA Color Systems (Wyszecki, 1982d) are used to test the uniformity of the IQRGB model as compared to the CIE xyY and CIELAB color spaces. The comparisons are all made at a CIELAB-L* of 50.0. FIG. 19 displays the CIExyY data determined by the OSA committee. Also shown in FIG. 19 is the IQRGB transformation of the CIE xyY data along with the CIELAB transformation. In comparison, the IQRGB model appears to produce a more uniform spacing of data points than does CIELAB.

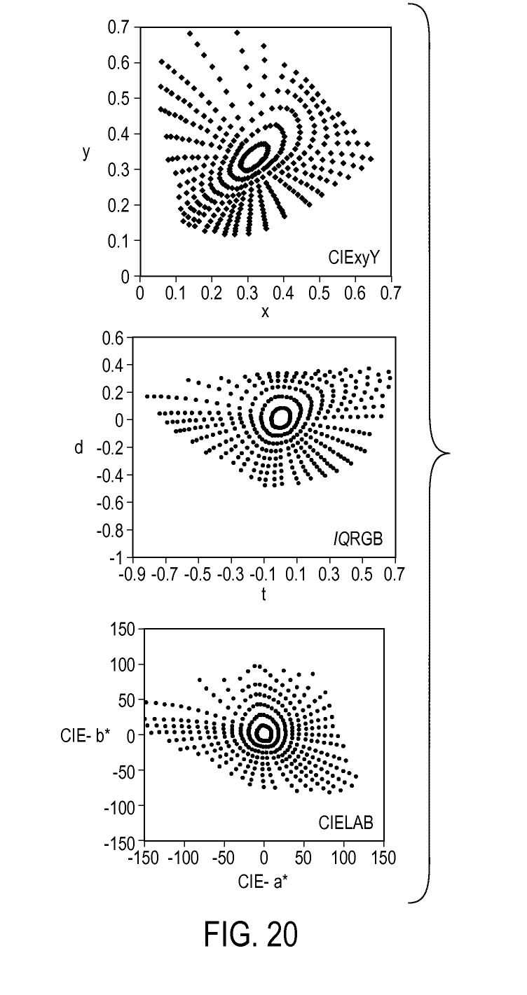

The Munsell Renotation System (Wyszecki, 1982e) is another well-researched uniform color scale. FIG. 20 plots the CIE xyY data at the level where CIE-L*=50.0. This data is corrected to a D65 white point. This is necessary since the IQRGB color system assumes a D65 white. The figure displays the IQRGB transformed Munsell data. In like manner, FIG. 20 shows the D65 normalized Munsell data transformed to CIELAB. Again, the IQRGB model generates uniform data point spacing. The CIELAB transformation produces exaggerated saturation spacing for the yellow region. The hue angle spacing appears to be less even with a large gap in the green region. The CIELAB lines of constant hue have much more curvature than those of IQRGB.

Small Color Differences

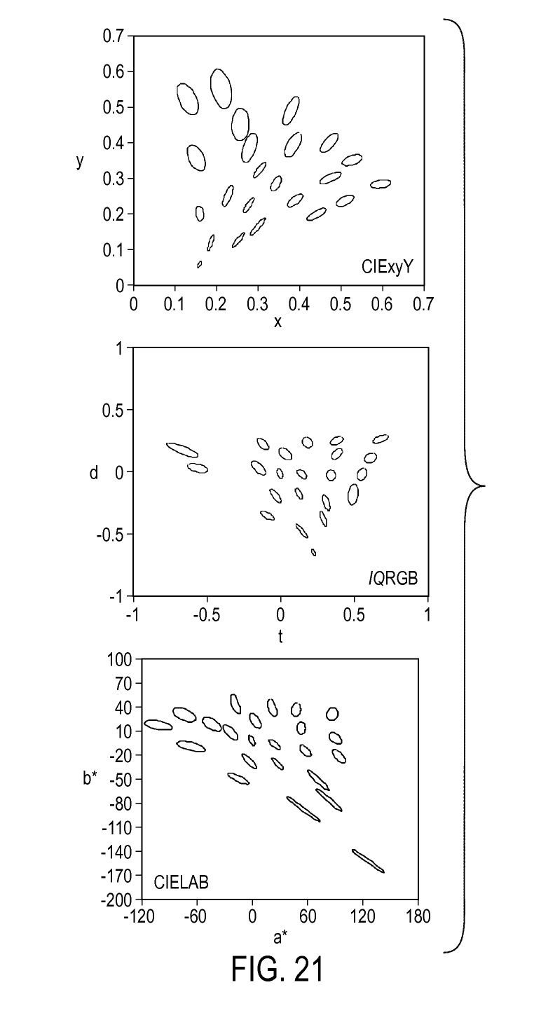

MacAdam's (Wyszecki, 1982f) color matching ellipse experiment is well known. His data, shown in FIG. 21, was used as a further test of the IQRGB model. One problem with this data is that other experimenters, including MacAdam, have not been able to repeat his original experiment. Many factors such as acuity, age, and observer metamerism influence the discrimination task. All of these effects lead to large variations in the orientation, eccentricity and size of the ellipses. Since there is large variance among observers, both the color matching ellipse data of MacAdam and that of Wyszecki-Fielder (observer G. F.) (Wyszecki, 1982g) were used to test of the IQRGB model.

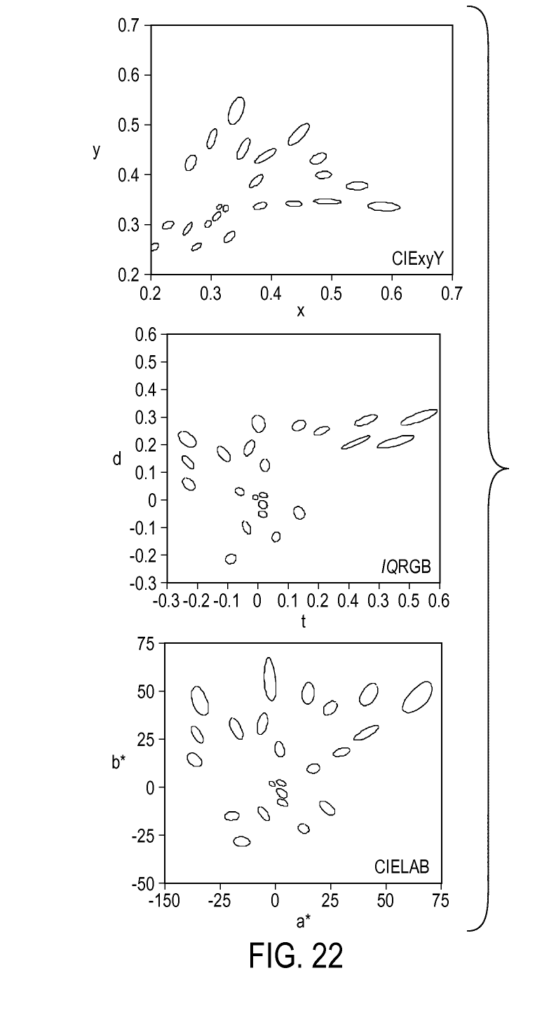

FIG. 22 shows the comparison of the Qtd and CIELAB transformations of the Wyszecki-Fielder ellipse data. The IQRGB transformation produces more uniform ellipses than CIELAB for both the MacAdam and the Wyszecki-Fielder test samples. The Wyszecki-Fielder data was not included in determination of the Qtd color space and therefore the IQRGB transformation was not tuned for the color matching ellipse data. As shown in the sections above, the IQRGB model performs well for the entire set of tests.

Conclusions from Testing

IQRGB, the companion ATD luminance-chromanance color space and the Qtd appearance space have been tested against a wide variety of visual data and are found to produce a reasonable uniform color space for application in the graphic arts. The IQRGB has introduced the concept of the Real World of colors that encompasses all of the surface colors in nature and industry. The IQRGB color space is introduced as an efficient vector set that is a compact support for the Real World. The IQRGB vectors are chosen so that a simple binary integer transformation of the vectors produces a reasonably uniform color space. The ATD-Qtd color space is developed for efficient communication of color data.

### REFERENCES

The following references, some of which were referred to above, are incorporated by reference:
Granger, E. M. 1994 “ATD, Appearance Equivalence, and Desktop Publishing”, SPIE, Vol. 2170;
Granger, E. M. 1997 U.S. Pat. No. 5,650,942 “Appearance-Based Technique for Rendering Colors on an Output Device”;
Granger, E. M. 1999 U.S. Pat. No. 6,005,968 “Scanner Calibration and Correction Techniques Using Scaled Lightness Values”; and
Granger, E. M. 2000 U.S. Pat. No. 6,134,029 “Scanner Calibration Technique”.
Sanchez, M. and Fairchild, M. 2001 “Perceptual Amplification of Color: Observer Data and Models,” CIC9, Ninth Color Conference, Scottsdale, Ariz.; and
Wyszecki, G. and Stiles, W. S. 1982 “Color Science: Concepts and Methods, Quantitative Data and Formulae” (Wiley, New York), 2nd ed (“Wyszecki”) including
   Wyszecki 1982a, pp. 615 et seq.;
   Wyszecki 1982b,” pp. 410 et seq.;
   Wyszecki 1982c, pp. 570 et seq.;
   Wyszecki 1982d, pp. 871 et seq.;
   Wyszecki 1982e, pp. 840 et seq.;
   Wyszecki 1982f, pp. 309 et seq.; and
   Wyszecki 1982g, pp. 801 et seq.

### CONCLUSION

While the above is a complete description of specific embodiments of the invention, the above description should not be taken as limiting the scope of the invention as defined by the claims.

What is claimed is:

1. A processor-implemented method of determining colorant values for reproduction of an image, the method comprising:
providing as input a first plurality of tristimulus values for a selected pixel of the image;
determining an output hue for the selected pixel;
determining an output saturation for the selected pixel;
determining an output darkness for the selected pixel, wherein the output darkness is constrained nonlinearly by a minimum darkness of a substrate and a maximum darkness of selected colorants applied to the substrate; and
determining a corresponding plurality of colorant values for the output hue, output saturation and output darkness of the selected pixel.

2. The method of claim 1, wherein the determination of the output saturation for the selected pixel further comprises:
constraining the saturation below a corresponding chromaticity gain limit.

3. The method of claim 2, wherein the step of constraining the saturation below the corresponding chromaticity gain limit further comprises:
determining the corresponding chromaticity gain limit as a maximum perceived chromaticity as a function of increasing colorant saturation.

4. A computer-implemented method of providing a plurality of neutral color values for reproduction of an image on an output medium, a black colorant applied to the output medium having a maximum black colorant darkness, the method comprising:
providing a black colorant in substantially linear increments to the maximum black colorant darkness to provide a plurality of black increments;
providing a first plurality of primary colorants at about a first colorant level; and
combining the first plurality of primary colorants with each black increment of the plurality of black increments to form a first plurality of neutral increment values.

5. The method of claim 4, wherein the first colorant level is between about 6 to 7 percent saturation.

6. The method of claim 4, further comprising:
providing a second plurality of primary colorants at about a second colorant level, the second colorant level comparatively lower than the first colorant level; and
combining the second plurality of primary colorants with each black increment of the plurality of black increments to form a second plurality of neutral increment values.

7. A calibration method comprising:
providing a set of calibration samples including at least one region of bare substrate and a plurality of color patches on the substrate where each color patch has known commanded colorants and coverage;
for each color patch and region of bare substrate,
generating reflectivity values for each of a plurality of wavelengths, and
for each wavelength, dividing the color patch reflectivity by the substrate reflectivity to provide a substrate-independent reflectivity value;
using the resulting substrate-independent reflectance spectra to generate a set of tristimulus values for each color patch; and
storing information regarding the tristimulus values for subseqent use in connection with commands to render a particular color.

8. A calibration method comprising:
providing a set of calibration samples including at least one region of bare substrate and a plurality of color patches on the substrate where each color patch has known commanded colorants and coverage;
for each color patch and region of bare substrate,
generating reflectivity values for each of a plurality of wavelengths, and
for each wavelength, dividing the color patch reflectivity by the substrate reflectivity to provide a substrate-independent reflectivity value;
for each family of patches with the same colorant combinations at different commanded coverages, find a patch of minimum reflectivity, referred to as R(min), in any spectral band;
for remaining patches in that family, generating normalized dot coverage based on the reflectance R(patch) of that patch and R(min).

9. The method of claim 8 wherein:
a dot area is calculated according to the formula is (1−Rpatch)/(1−Rmin); and
a dot gain is obtained by subtracting a requested dot area from a measured dot area.

10. A method of determining colorant values for rendering a color on a target printer wherein the target printer responds to commands specifying amounts of a set of colorants, the method comprising:
in response to a commanded color, accessing a set of calibration data based on a color model that is characterized by a set of three meta primaries, meta R, meta G, and meta B, wherein:
the set of meta primaries are at positions in a chromaticity space such that a triangle joining the meta primaries compactly encloses a color gamut that corresponds to the maximum gamut spanned by real world colors, and
one of the axes of the color model passes through unique blue on the spectrum locus and unique yellow on the spectrum locus;
using the calibration information to generate colorant commands.

11. The method of claim 10, and further comprising invoking the colorant commands to render the commanded color.

12. The method of claim 10 wherein the color model is characterized by a brightness component that accounts for differences in perceived brightness for colors having the same measured luminosity.

13. The method of claim 10 wherein the red primary is located at CIE (x, y) coordinates (0.7844, 0.3128), the green primary at (0.2602, 0.6650) and the blue primary at (0.0267, 0.0000).

14. A method of determining colorant values for rendering a color on a target printer wherein the target printer responds to commands specifying amounts of a set of colorants, the method comprising:
in response to a commanded color, accessing a set of calibration data based on a color model that is characterized by a set of three meta primaries, meta R, meta G, and meta B, wherein:
the color model is characterized by a tristimulus ATD space defined as follows:
A=R+3*G,
T=R−G, and
D=(R+G)/2−B;
the color model is characterized by a brightness term Q that takes the Helmholtz-Kohlrausch into account as follows:
Q=A+T/2 if D>0
Q=A+T/2−3D/4, otherwise,
with chromaticity coordinates “t” and “d” defined relative to Q as follows:
t=T/Q and d=D/Q.

15. The method of claim 14 wherein the red primary is located at CIE (x, y) coordinates (0.7844, 0.3128), the green primary at (0.2602, 0.6650) and the blue primary at (0.0267, 0.0000).
